(19) United States
(12) Patent Application Publication
(10) Pub. No.: US 2018/0257622 A1
(43) Pub. Date: Sep. 13, 2018

(54) Pump Device and Braking System

(71) Applicant: Hitachi Automotive Systems, Ltd., Hitachinaka-shi, Ibaraki (JP)

(72) Inventors: Masayuki SAITO, Machida-shi, Tokyo (JP); Chiharu NAKAZAWA, Kawasaki-shi, Kanagawa (JP); Masaki MISUNO, Atsugi-shi, Kanagawa (JP)

(21) Appl. No.: 15/754,884

(22) PCT Filed: Aug. 3, 2016
(86) PCT No.: PCT/JP2016/072747

§ 371 Date: Feb. 23, 2018

(30) Foreign Application Priority Data
Aug. 26, 2015 (JP) 2015-166544

(51) Int. Cl. B60T 13/20; B60T 13/74; B60T 13/66; B60T 17/02; B60T 15/02

(52) U.S. Cl. CPC B60T 13/20; B60T 13/745; B60T 15/028; B60T 17/02; B60T 13/66

(57) ABSTRACT

Provided is a pump device capable of suppressing an increase in size of a housing. The pump device includes: a housing including therein an oil passage and a pump; a motor configured to drive the pump; a motor mounting surface which is formed on one side surface of the housing, and to which the motor is mounted; a first port which is formed on the motor mounting surface, and to which a pipe connected to a master cylinder is mounted; a first surface formed so as to continue to the motor mounting surface, and including a second port to which a pipe connected to a wheel cylinder is mounted; a second surface formed so as to continue to the motor mounting surface and the first surface; and a third port which is formed on the second surface, and to which a pipe connecting an external device and the oil passage to each other is fixed.

### TECHNICAL FIELD

The present invention relates to a pump device.

### BACKGROUND ART

Hitherto, there has been known a pump device including a motor and a housing. For example, according to a device described in Patent Literature 1, in a housing, a surface to which the motor is mounted has a port to which a pipe connected to a master cylinder is mounted, and a surface continuing to the surface to which the motor is mounted has ports to which pipes connected to wheel cylinders are mounted.

### CITATION LIST

### Patent Literature

PTL 1: JP 2009-234372 A

### SUMMARY OF INVENTION

### Technical Problem

However, the size of the housing may increase in the related-art device. The present invention therefore has an object to provide a pump device capable of suppressing the increase in size of the housing.

### Solution to Problem

According to one embodiment of the present invention, a pump device includes a port which is formed on a surface continuing to both a surface to which a motor is mounted and a surface continuing to the surface to which the motor is mounted, and to which a pipe connected to an external device is mounted.

Thus, the increase in size of the housing can be suppressed.

### BRIEF DESCRIPTION OF DRAWINGS

FIG. 1 is a schematic configuration diagram for illustrating a braking system according to a first embodiment.

FIG. 2 is a perspective view for illustrating a part of the braking system according to the first embodiment.

FIG. 3 is a sectional view for illustrating a first unit in the first embodiment.

FIG. 4 is a front transparent view for illustrating a housing of a second unit in the first embodiment.

FIG. 5 is a rear transparent view for illustrating the housing of the second unit in the first embodiment.

FIG. 6 is a top transparent view for illustrating the housing of the second unit in the first embodiment.

FIG. 7 is a bottom transparent view for illustrating the housing of the second unit in the first embodiment.

FIG. 8 is a right side transparent view for illustrating the housing of the second unit in the first embodiment.

FIG. 9 is a left side transparent view for illustrating the housing of the second unit in the first embodiment.

FIG. 10 is a front view for illustrating the second unit in the first embodiment.

FIG. 11 is a rear view for illustrating the second unit in the first embodiment.

FIG. 12 is a right side view for illustrating the second unit in the first embodiment.

FIG. 13 is a left side view for illustrating the second unit in the first embodiment.

FIG. 14 is a top view for illustrating the second unit in the first embodiment.

FIG. 15 is a sectional view as viewed in a direction indicated by the line XV-XV of FIG. 14.

FIG. 16 is a rear view for illustrating the second unit in the first embodiment in a state in which a case lid part of an ECU is removed.

FIG. 17 is a right side view for illustrating the second unit of the first embodiment with transparency in the housing.

FIG. 18 is a front transparent view for illustrating the housing of the second unit in a second embodiment.

FIG. 19 is a transparent perspective view for illustrating the housing of the second unit in the second embodiment.

### DESCRIPTION OF EMBODIMENTS

Now, embodiments of the present invention are described based on the drawings.

### First Embodiment

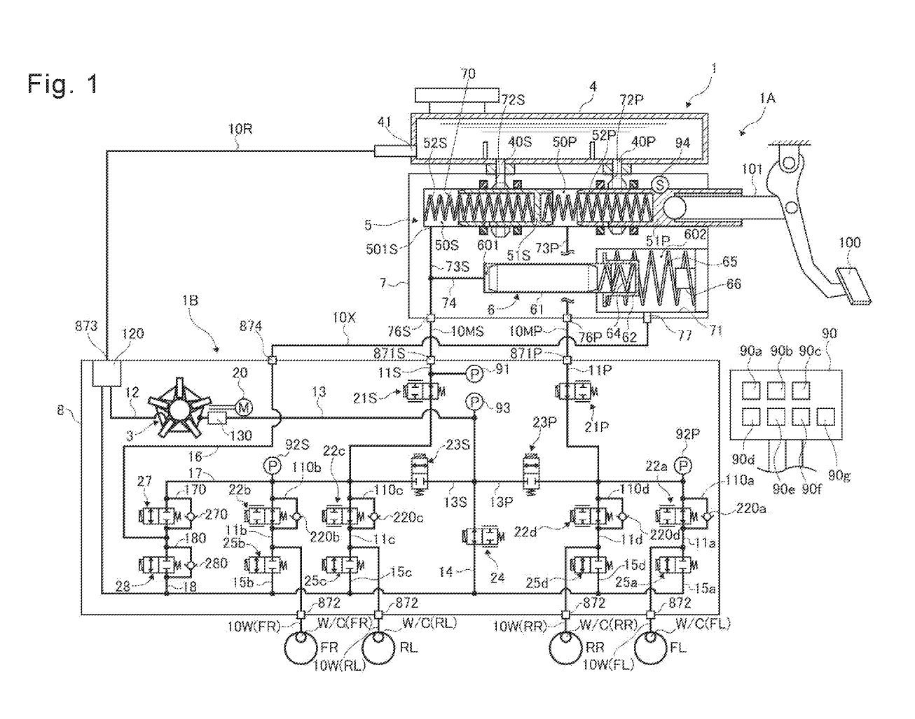

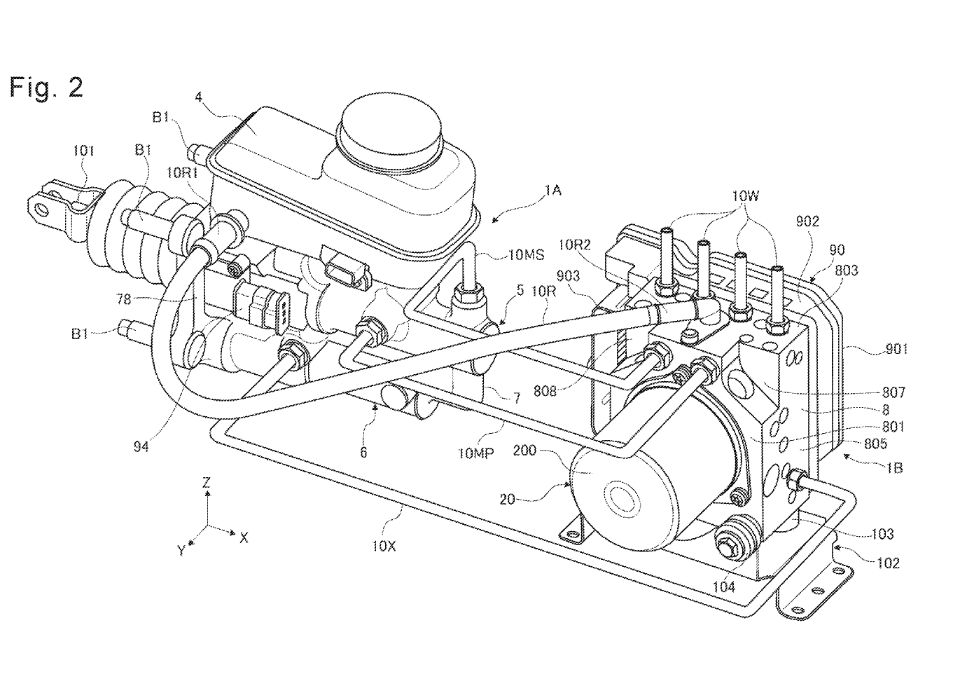

First, description is given of a configuration. FIG. 1 is a diagram for illustrating a schematic configuration of a braking system 1 according to the first embodiment together with a hydraulic circuit. FIG. 2 is a perspective view for illustrating a part of the braking system 1. The braking system 1 is applied to an electrically driven vehicle. The electrically driven vehicle refers to, for example, a hybrid vehicle including an electric motor (generator) in addition to an internal combustion engine (engine) as a motor for driving wheels, or an electric automobile including only an electric motor (generator) as a motor for driving wheels. In the electrically driven vehicle, regenerative braking, that is, breaking of the vehicle by regenerating electric energy from kinetic energy of the vehicle can be performed with use of a regenerative braking device including a motor (generator). The braking system 1 is a hydraulic pressure braking device configured to apply friction braking forces through hydraulic pressures to wheels FL to RR of the vehicle. A brake operation unit is provided for each of the wheels FL to RR. The brake operation unit is a hydraulic pressure generation part including a wheel cylinder W/C. The brake operation unit is of, for example, a disc type, and includes a caliper (hydraulic brake caliper). The caliper includes a brake disc and brake pads. The brake disc is a brake rotor rotating integrally with a tire. The brake pads are arranged so as to have predetermined clearances to the brake disc, and are moved by the hydraulic pressures of the wheel cylinder W/C, to thereby come into contact with the brake disc. As a result, a friction braking force is generated. The braking system I includes two systems (primary P system and secondary S system) of brake pipes. The brake pipe type is, for example, an X-split pipe type. Other pipe types such as a front/rear-split pipe may be employed. Hereinafter, when a member correspondingly provided to the P system and a member correspondingly provided to the S system are distinguished from one other, suffixes P and S are added to respective reference symbols. The braking system 1 is configured to supply the brake fluid serving as working fluid (working oil) to each of the brake operation units through the brake pipes, to thereby generate hydraulic pressures (brake hydraulic pressures) in the wheel cylinders W/C. As a result, a hydraulic pressure braking force is applied to each of the wheels FL to RR.

The braking system 1 includes a first unit 1 A and a second unit 1B. The first unit 1A and the second unit 1B are provided in a motor room isolated from a cabin of the vehicle, and are connected to each other by a plurality of pipes. The plurality of pipes include master cylinder pipes 10M (primary pipe 10MP and secondary pipe 10MS), wheel cylinder pipes 10W, a back pressure pipe 10X, and a suction pipe 10R. Each of the pipes 10M, 10W, and 10X other than the suction pipe 10R is a brake pipe made of metal (metal pipe), specifically, for example, a double-wound steel pipe. Each of the pipes 10M, 10W, and 10X has straight portions and bent portions, and is arranged between ports while the direction is changed at the bent portions. Both ends of each of the pipes 10M, 10W, and 10X include flared male pipe joints. The suction pipe 10R is a brake hose (hose pipe) made of a material such as rubber so as to be flexible. Ends of the suction pipe 10R are connected to a port 873 and the like by nipples 10R1 and 10R2. The nipples 10R1 and 10R2 are resin connection members including pipe portions.

A brake pedal 100 is a brake operation member configured to receive an input of a brake operation by a driver. A pushrod 101 is rotatably connected to the brake pedal 100. The first unit 1A is a brake operation unit mechanically connected to the brake pedal 100, and is a master cylinder unit including a master cylinder 5. The first unit 1A includes a reservoir tank 4, a housing 7, the master cylinder 5, a stroke sensor 94, and a stroke simulator 6. The reservoir tank 4 is a brake fluid source for reserving the brake fluid, and is a low-pressure part opened to the atmospheric pressure. Supplement ports 40 and a supply port 41 are formed in the reservoir tank 4. The suction pipe 10R, is connected to the supply port 41. The housing 7 is a casing for accommodating (build in) the master cylinder 5 and the stroke simulator 6 therein. A cylinder 70 for the master cylinder 5, a cylinder 71 for the stroke simulator 6, and a plurality of oil passages (liquid passages) are formed in the housing 7. The plurality of oil passages include supplement oil passages 72, supply oil passages 73, and a positive pressure oil passage 74. A plurality of ports are formed in the housing 7, and those ports are opened in outer surfaces of the housing 7. The plurality of ports include supplement ports 75P and 75S, supply ports 76, and a back pressure port 77. The supplement ports 75P and 755 are connected to supplement ports 40P and 40S of the reservoir tank 4, respectively. The master cylinder pipes 10M are connected to the supply ports 76, and the back pressure pipe 10X is connected to the back pressure port 77. One end of the supplement oil passage 72 is connected to the supplement port 75, and the other end is connected to the cylinder 70.

The master cylinder S is a first hydraulic pressure source capable of supplying an operation hydraulic pressure to the wheel cylinders W/C. The master cylinder 5 is connected to the brake pedal 100 via the pushrod 101, and is operated in accordance with an operation on the brake pedal 100 by the driver. The master cylinder 5 includes a piston 51 which is moved in an axial direction in accordance with the operation on the brake pedal 100. The piston 51 is accommodated in the cylinder 70, and defines hydraulic pressure chambers 50. The master cylinder 5 is of a tandem type, and includes, as pistons 51, a primary piston 51P connected to the pushrod 101 and a secondary piston 51S of a free piston type in series. A primary chamber 50P is defined by the pistons 51P and 51S, and a secondary chamber 50S is defined by the secondary piston 51S. One end of the supply oil passage 73 is connected to the hydraulic pressure chamber 50, and the other end is connected to the supply port 76. Each of the hydraulic pressure chambers 50P and 505 is supplemented with the brake fluid from the reservoir tank 4 to generate a hydraulic pressure (master cylinder pressure) through the movement of the piston 51. The stroke sensor 94 is configured to detect a stroke (pedal stroke) of the primary piston 51P. A magnet for detection is provided in the primary piston 51P, and a sensor main body is mounted to an outer surface of the housing 7 of the first unit 1A.

The stroke simulator 6 is operated in accordance with the brake operation by the driver, and is configured to apply a reaction force and a stroke to the brake pedal 100. The stroke simulator 6 includes a piston 61, a positive pressure chamber 601 and a back pressure chamber 602 defined by the piston 61, and an elastic body (spring 64 or the like) configured to bias the piston 61 in a direction in which the volume of the positive pressure chamber 601 decreases. One end of the positive pressure oil passage 74 is connected to a supply oil passage 73S on the secondary side, and the other end is connected to the positive pressure chamber 601. The pedal stroke is generated by inflow of the brake fluid from the master cylinder 5 (secondary chamber 50S) to the positive pressure chamber 601 in accordance with the brake operation by the driver, and a reaction force against a brake operation by the driver is generated by the biasing force of the elastic body. The first unit 1A does not include an engine negative pressure booster configured to boost the brake operation force through use of an intake negative pressure generated in the engine of the vehicle.

The second unit 1B is a hydraulic pressure control unit provided between the first unit 1A and the brake operation units. The second unit 1B is connected to the primary chamber 50P by the primary pipe 10MP (first pipe), is connected to the secondary chamber 50S by the secondary pipe 10MS (first pipe), is connected to the wheel cylinders W/C by the wheel cylinder pipes 10W (second pipes), and is connected to the back pressure chamber 602 by the back pressure pipe 10X (third pipe). Moreover, the second unit 1B is connected to the reservoir tank 4 by the suction pipe 10R. The second unit 1B includes a housing 8, a motor 20, a pump 3, a plurality of electromagnetic valves 21, a plurality of hydraulic pressure sensors 91, and an electronic control unit 90 (control unit, hereinafter referred to as “ECU”). The housing 8 is a casing for accommodating (build in) the pump 3, valve bodies of the electromagnetic valves 21, and the like therein. Circuits (brake hydraulic pressure circuits) of the two systems (P system and S system), through which the brake fluid circulates, are formed of a plurality of oil passages in the housing 8. The plurality of oil passages include supply oil passages 11, a suction oil passage 12, discharge oil passages 13, a pressure regulating oil passage 14, pressure reducing oil passages 15, a back pressure oil passage 16, a first simulator oil passage 17, and a second simulator oil passage 18. Moreover, a reservoir (internal reservoir) 120, which is a liquid reservoir, and a damper 130 are formed in the housing 8. A plurality of ports are formed in the housing 8, and those ports are opened in outer surfaces of the housing 8. The plurality of ports include master cylinder ports 871 (primary ports 871P and secondary ports 871S), a suction port 873, a back pressure port 874, and wheel cylinder ports 872. The primary pipe 10MP, the secondary pipe 10MS, the suction pipe 10R, the back pressure pipe 10X, and the wheel cylinder pipes 10W are mounted and connected to the primary port 871P, the secondary port 871S, the suction port 873, the back pressure port 874, and the wheel cylinder ports 872, respectively.

The motor 20 is an electric motor of a rotation type, and includes a rotation shaft configured to drive the pump 3. The motor 20 may be a brushless motor or a brush motor. The motor 20 includes a resolver configured to detect a rotation angle of the rotation shaft. The resolver functions as a number-of-revolution sensor configured to detect the number of revolutions of the motor 20. The pump 3 is a hydraulic pressure source capable of supplying an operation hydraulic pressure to the wheel cylinders W/C, and includes five pump parts 3A to 3E driven by the single motor 20. The pump 3 is used for the S system and the P system in common. Each of the electromagnetic valves 21 and the like is an actuator configured to operate in accordance with a control signal, and includes a solenoid and a valve body. The valve body is configured to perform a stroke in accordance with a current supply to the solenoid to switch opening and closing of an oil passage (open/close the oil passage). Each of the electromagnetic valves 21 and the like controls the communication state of the circuit and adjusts the circulation state of the brake fluid to generate a control hydraulic pressure. The plurality of electromagnetic valves 21 and the like include shutoff valves 21, pressure boosting valves (hereinafter referred to as “SOL/V IN”) 22, communication valves 23, a pressure regulating valve 24, pressure reducing valves (hereinafter referred to as “SOL/V OUT”) 25, a stroke simulator-in valve (hereinafter referred to as “SS/V IN”) 27, and a stroke simulator-out valve (hereinafter referred to as “SS/V OUT”) 28. Each of the shutoff valve 21, the SOL/V IN 22, and the regulating valve 24 is a normally-open valve which is opened in a non-current supply state. Each of the communication valve 23, the pressure reducing valve 25, the SS/V IN 27, and the SS/V OUT 28 is a normally-closed valve, which is closed in the non-current supply state. Each of the shutoff valve 21, the SOL/V IN 22, and the pressure regulating valve 24 is a proportional control valve which has an opening degree adjusted in accordance with the current supplied to the solenoid. Each of the communication valve 23, the pressure reducing valve 25, the SS/V IN 27, and the SS/V OUT 28 is an ON/OFF valve which is subjected to binary switching control between an opening state and a closing state. A proportional control valve may be used for each of those valves. Each of the hydraulic pressure sensor 91 and the like is configured to detect a discharge pressure of the pump 3 or a master cylinder pressure. The plurality of hydraulic pressure sensors include a master cylinder pressure sensor 91, a discharge pressure sensor 93, and wheel cylinder pressure sensors 92 (primary pressure sensor 92P and secondary pressure sensor 92S).

Now, based on FIG. 1, description is given of the brake hydraulic pressure circuit of the second unit 1B. For members corresponding to the respective wheels FL to RR, suffixes of “a” to “d” are added to respective reference symbols for proper distinction. One end side of a supply oil passage 11P is connected to the primary port 871P. The other end side of the supply oil passage 11P is branched into an oil passage 11a for the front left wheel and an oil passage 11d for the rear right wheel. Each of the oil passages 11a and 11d is connected to the corresponding wheel cylinder port 872. One end side of a supply oil passage 11S is connected to the secondary port 871S. The other end side of the supply oil passage 11S is branched into an oil passage 11b for the front right wheel and an oil passage 11c for the rear left wheel. Each of the oil passages 11b and 11c is connected to the corresponding wheel cylinder port 872. The shutoff valve 21 is provided on the one end side of each of the supply oil passages 11. The SOL/V IN 22 is provided on the other end side of each of the oil passages 11. A bypass oil passage 110 configured to bypass the SOL/V IN 22 is provided in parallel with each of the oil passages 11. A check valve 220 is provided in the bypass oil passage 110. The check valve 220 permits only a flow of the brake fluid from the wheel cylinder port 872 side to the master cylinder port 871 side.

The suction oil passage 12 connects the reservoir 120 and suction ports 823 of the pump 3 to each other. One end side of the discharge oil passage 13 is connected to discharge ports 821 of the pump 3. The other end side of the discharge oil passage 13 is branched into the oil passage 13P for the P system and the oil passage 13S for the S system. Each of the oil passages 13P and 13S is connected to a portion between the shutoff valve 21 and the SOL/V IN 22 in the supply oil passage 11. A damper 130 is provided on the one end side of the discharge oil passage 13. The communication valve 23 is provided in each of the oil passages 13P and 13S on the other end side. The respective oil passages 13P and 13S function as communication passages for connecting the supply oil passage 11P in the P system and the supply oil passage 11S in the S system to each other. The pump 3 is connected to the respective wheel cylinder ports 872 by the communication passages (discharge oil passages 13P and 13S) and the supply oil passages 11P and 11S. The pressure regulating oil passage 14 connects an intermediate portion of the discharge oil passages 13 between the damper 130 and the communication valves 23, and the reservoir 120 to each other. The pressure regulating valve 24 serving as a first pressure reducing valve is provided in the pressure regulating passage 14. The pressure reducing oil passage 15 connects an intermediate portion between the SOL/V IN 22 in each of the oil passages 11a to 11d of the supply oil passage 11 and the wheel cylinder port 872 and the reservoir 120 to each other. The SOL/V OUT 25 serving as a second pressure reducing valve is provided in the pressure reducing oil passage 15.

One end side of the back pressure oil passage 16 is connected to the back pressure port 874. The other end side of the back pressure oil passage 16 is branched into a first simulator oil passage 17 and a second simulator oil passage 18. The first simulator oil passage 17 is connected a portion between the shutoff valve 21S and the SOL/V IN 22b and 22c in the supply oil passage 11S. The SS/V IN 27 is provided in the first simulator oil passage 17. A bypass oil passage 170 configured to bypass the SS/V IN 27 is provided in parallel with the first simulator oil passages 17. A check valve 270 is provided in the bypass oil passage 170. The check valve 270 permits only a flow of the brake fluid from the back pressure oil passage 16 side to the supply oil passage 11S side. The second simulator oil passage 18 is connected to the reservoir 120. The SS/V OUT 28 is provided in the second simulator oil passage 18. A bypass oil passage 180 configured to bypass the SS/V OUT 28 is provided in parallel with the second simulator oil passages 18. A check valve 280 is provided in the bypass oil passage 180. The check valve 280 permits only a flow of the brake fluid from the reservoir 120 side to the back pressure oil passage 16 side.

A hydraulic pressure sensor 91 is provided at an intermediate position between the shutoff valve 21S in the supply oil passage 11S and the secondary port 871S. The hydraulic pressure sensor 91 is configured to detect a hydraulic pressure at this position (hydraulic pressure in the positive pressure chamber 601 of the stroke simulator 6, or the master cylinder pressure). A hydraulic pressure sensor 92 is provided at an intermediate position between the shutoff valve 21 in the supply oil passage 11 and the SOL/V INs 22. The hydraulic pressure sensor 92 is configured to detect a hydraulic pressure at this point (corresponding to the wheel cylinder hydraulic pressure). A hydraulic pressure sensor 93 is provided at an intermediate point between the damper 130 in the discharge oil passage 13 and the communication valves 23. The hydraulic pressure sensor 93 is configured to detect a hydraulic pressure at this point (pump discharge pressure).

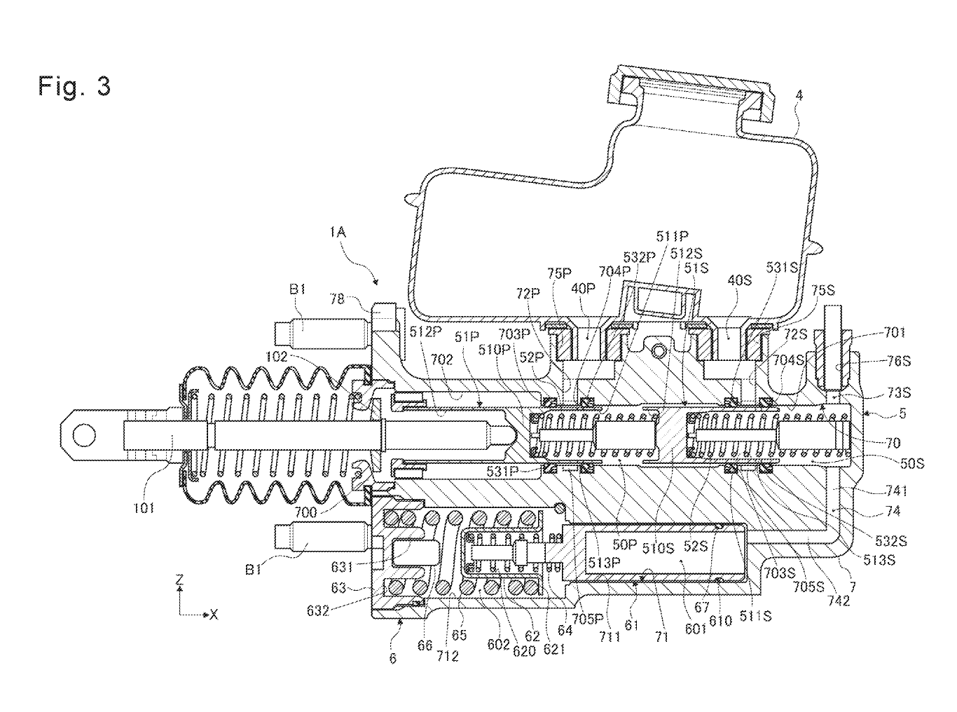

Next, detailed description is given of the first unit 1A. FIG. 3 is a sectional view for illustrating the first unit 1A. Hereinafter, for convenience of description, a three-dimensional Cartesian coordinate system including an X axis, a Y axis, and a Z axis is given. In a state in which the first unit 1A is mounted to the vehicle, a Z-axis direction is the vertical direction, and a positive side in the Z-axis direction is a top side in the vertical direction. An X-axis direction is a front/rear direction of the vehicle, and a positive side in the X-axis direction is the vehicle front side. A Y-axis direction is a lateral direction of the vehicle. The pushrod 101 extends from the end on a negative side in the X-axis direction, which is connected to the brake pedal 100, to the positive side in the X-axis direction. A rectangular plate-like flange part 78 is provided at an end on the negative side in the X-axis direction of the housing 7. Bolt holes are formed in four corners of the flange part 78. A bolt B1 for fixing and mounting the first unit 1A to a dash panel on a vehicle body side passes through the bolt hole. The reservoir tank 4 is provided on the positive side in the Z-axis direction of the housing 7. The reservoir tank 4 is within the width of the flange part 78 in the Y-axis direction. The reservoir tank 4 covers a most part (a part excluding the flange part 78 and an end on the positive side in the X-axis direction) of the housing 7 as viewed from the positive side in the Z-axis direction. A supply port 41 is formed on a surface on a positive side in the Y-axis direction at an end on the negative side in the X-axis direction and on a bottom part side (on the negative side in the Z-axis direction) of the reservoir tank 4. The nipple 10R1 is fixedly provided in the supply port 41, and one end of the suction pipe 10R is connected to the nipple 10R1.

The cylinder 70 for the master cylinder 5 has a bottomed tubular shape extending in the X-axis direction. A positive side in the X-axis direction of the cylinder 70 is closed and a negative side in the X-axis direction of the cylinder 70 is opened. The cylinder 70 includes a small-diameter part 701 on the positive side in the X-axis direction, and a large-diameter part 702 on the negative side in the X-axis direction. The small-diameter part 701 includes two seal grooves 703 and 704 and one port 705 for each of the P and S systems. Each of the seal grooves 703 and 704 and the port 705 has an annular shape extending in a circumferential direction of an axial center of the cylinder 70. The port 705 is formed between the two seal grooves 703 and 704. The cylinder 71 for the stroke simulator 6 is arranged on the negative side in the Z-axis direction of the cylinder 70. The cylinder 71 has a bottomed tubular shape extending in the X-axis direction. A positive side in the X-axis direction of the cylinder 71 is closed and a negative side in the X-axis direction of the cylinder 71 is opened. The cylinder 71 includes a small-diameter part 711 on the positive side in the X-axis direction, and a large diameter part 712 on the negative side in the X-axis direction. The cylinders 70 and 71 are within the width of the flange part 78 in the Y-axis direction.

The supply port 76S on the secondary side and both the supplement ports 75 are formed on a surface on the positive side in the Z-axis direction of the housing 7. The supply port 76S is formed at an end on the positive side in the X-axis direction of the housing 7. One end of the secondary pipe 10MS is fixedly provided in the supply port 76S. The supplement port 75S on the secondary side is formed on the negative side in the X-axis direction with respect to the supply port 76S. The supplement port 75P on the primary side is formed on the negative side in the X-axis direction with respect to the supplement port 75S. The supply port 76P on the primary side and the back pressure port 77 are formed on a surface (side surface) on the positive side in the Y-axis direction of the housing 7. The supply port 76P is formed at a position partially overlapping in the X-axis direction with the supplement port 75S on the secondary side, on the positive side in the Z-axis direction on the above-mentioned surface. One end of the primary pipe 10MP is fixedly provided in the supply port 76P. Specifically, a pipe joint at the end of the primary pipe 10MP is fitted to the supply port 76P, is sandwiched between a hexagon nut and the housing 7, and is fixed through tightening, and, consequently, the end is connected to the supply port 76P. Hereinafter, the other end of the primary pipe 10MP, and both ends of the metal pipes 10MS, 10W, and 10X are connected to the ports in the same manner.

The back pressure port 77 is formed on the negative side in the Z-axis direction with respect to the supply port 76S on the secondary side, and partially overlaps in the X-axis direction with the supplement port 75P on the primary side. One end of the back pressure pipe 10X is fixedly provided in the back pressure port 77. A supplement oil passage 72P on the primary side extends from the supplement port 75P on the primary side to the negative side in the Z-axis direction, and is opened in a port 705P. A supplement oil passage 72S on the secondary side extends from the supplement port 75S on the secondary side to the negative side in the Z-axis direction, and is opened in a port 705S. A supplement oil passage 73P on the primary side extends from the supplement port 76P on the primary side to a negative side in the Y-axis direction, and is opened in the small-diameter part 701 of the cylinder 70. The supply oil passage 73S on the secondary side extends from the supply port 76S on the secondary side to the negative side in the Z-axis direction, and is opened in (an end on the positive side in the X-axis direction of) the small-diameter part 701 of the cylinder 70. The positive pressure oil passage 74 includes a part 741 extending from an end on the positive side in the X-axis direction of the small-diameter part 711 to the negative side in the Z-axis direction, and a part 742 extending from an end on the negative side in the Z-axis direction of the part 741 to the negative side in the X-axis direction, and is connected to an end on the positive side in the X-axis direction of the cylinder 71.

Each of the pistons 51 has a bottomed tubular shape, and is accommodated in the cylinder 70. The pistons 51P and 51S can move in the X-axis direction along an inner peripheral surface of the small-diameter part 701. The piston 51 includes a first recessed part 511 and a second recessed part 512 having a partition wall 510 as a common bottom part. A hole 513 passes through a peripheral wall of the first recessed part 511. The first recessed part 511 is formed on the positive side in the X-axis direction, and the second recessed part 512 is formed on the negative side in the X-axis direction. A positive side in the X-axis direction of the pushrod 101 is accommodated in the second recessed part 512P of the primary piston 51P. A semispherical round end of the pushrod 101 on the positive side in the X-axis direction abuts against the partition wall 510P. The pushrod 101 has a flange part 102. The movement of the pushrod 101 to the negative side in the X-axis direction is restricted by abutment between a stopper member 700 provided in an opening of the cylinder 70 (large-diameter part 702) and the flange part 102. In the small-diameter part 701, the primary chamber 50P is defined between the primary piston 51P (first recessed part 511P) and the secondary piston 51S (second recessed part 512S). The secondary chamber 505 is defined between the secondary piston 51S (first recessed part 511S) and an end on the positive side in the X-axis direction of the small-diameter part 701. A coil spring 52P serving as a return spring is provided in the primary chamber 50P while the coil spring 52P is compressed between the partition wall 510P and the partition wall 510S. A coil spring 52S serving as a return spring is provided in the secondary chamber 50S while the coil spring 52S is compressed between the partition wall 510S and the end on the positive side in the X-axis direction of the small-diameter part 701. The supply oil passages 73P and 73S are always opened in the chambers 50P and 50S, respectively.

Seal members 531 and 532 each having a cup shape are provided in the seal grooves 703 and 704, respectively. A rip part of each of the seal members 531 and 532 is brought into slide contact with an outer peripheral surface of the piston 51. On the primary side, the seal member 531P on the negative side in the X-axis direction is configured to suppress a flow of the brake fluid from the positive side in the X-axis direction (port 705P) to the negative side in the X-axis direction (large-diameter part 702). The seal member 532P on the positive side in the X-axis direction is configured to suppress a flow of the brake fluid to the negative side in the X-axis direction (port 705P), and permit a flow of the brake fluid to the positive side in the X-axis direction (primary chamber 50P). On the secondary side, the seal member 531S on the negative side in the X-axis direction is configured to suppress a flow of the brake fluid from the negative side in the X-axis direction (primary chamber 50P) to the positive side in the X-axis direction (port 705S). The seal member 532S on the positive side in the X-axis direction is configured to suppress a flow of the brake fluid to the negative side in the X-axis direction (port 705S), and permit a flow of the brake fluid to the positive side in the X-axis direction (secondary chamber 50S). In an initial state in which both the pistons 51P and 51S are maximally displaced to the negative side in the X-axis direction, the hole 513 is positioned (on a side closer to the seal member 532 in the positive side in the X-axis direction) between portions at which both the seal members 531 and 532 (rip parts) and the outer peripheral surface of the piston 51 are in contact with each other.

The master cylinder 5 is a hydraulic pressure source that is connected to the wheel cylinders W/C by the primary pipe 10MP, the secondary pipe 10MS, the supply oil passages 11P and 11S, and the wheel cylinder pipes 10W, and can increase the wheel cylinder hydraulic pressures. The brake fluid, which has flowed out from the master cylinder 5 through the brake operation by the driver flows to the master cylinder pipes 10M, and is taken into the supply oil passages 11 of the second unit 1B through the master cylinder ports 871. The master cylinder 5 can pressurize the wheel cylinders W/C (FL) and W/C (RR) via the oil passage (supply oil passage 11P) of the P system by the master cylinder pressure generated in the primary chamber 50P. Simultaneously, the master cylinder 5 can pressurize the wheel cylinders W/C (FR) and W/C (RL) via the oil passage (supply oil passage 11S) of the S system by the master cylinder pressure generated in the secondary chamber 50S.

The stroke simulator 6 includes a plug member 63, a piston 61, a retainer member 62, a first spring 64, and a second spring 65. The plug member 63 closes the opening of the cylinder 71 (large-diameter part 712). A first recessed part 631 having a bottomed tubular shape and a second recessed part 632 having a bottomed annular shape are provided on the positive side in the X-axis direction of the plug member 63. A damper 66 having a cylindrical shape is provided in the first recessed part 631. The damper 66 is an elastic member made of, for example, rubber. The piston 61 has a bottomed tubular shape having a recessed part, and is accommodated in the cylinder 71. An opening side of the recessed part is on the positive side in the X-axis direction. A seal groove 610 is formed in an outer peripheral surface of the piston 61. The piston 61 can move in the X-axis direction along an inner peripheral surface of the small-diameter part 711. An inside of the cylinder 71 is partitioned and separated into two chambers by the piston 61. A positive pressure chamber 601 (main chamber) as a first chamber is defined between the positive side in the X-axis direction (recessed part) of the piston 61 and the small-diameter part 711. A back pressure chamber 602 (sub chamber) as a second chamber is defined between the negative side in the X-axis direction (bottom part) of the piston 61 and the large-diameter part 712. A seal member (0 ring) 67 is provided in the seal groove 610. The seal member 67 is brought into slide contact with the inner peripheral surface of the small-diameter part 711. The positive pressure chamber 601 and the back pressure chamber 602 are separated from each other in a liquid tight manner by the seal member 67.

The retainer member 62 has a bottomed tubular shape including a recessed part 620, and includes a flange part 621 on an opening side of the recessed part 620. The retainer member 62, the first spring 64, and the second spring 65 are accommodated in the back pressure chamber 602. The first spring 64 is a coil spring having a large diameter, and is an elastic member configured to always bias the piston 61 to the positive pressure chamber 601 (direction of decreasing the volume of the positive pressure chamber 601, and increasing the volume of the back pressure chamber 602). One end of the first spring 64 is held on the first recessed part 631 of the plug member 63. The first spring 64 is provided in a compressed state between the plug member 63 and the retainer member 62 (flange part 621). The retainer member 62 is configured to hold the first spring 64. The second spring 65 is a coil spring having a small diameter and a spring constant smaller than that of the first spring 64, and is an elastic member configured to always bias the retainer member 62 toward the positive pressure chamber 601. One end of the second spring 65 is held on the recessed part 620 of the retainer member 62. The second spring 65 is provided in a compressed state between an end surface on the negative side in the X-axis direction (bottom part) of the piston 61 and the retainer member 62 (bottom part).

The stroke simulator 6 is configured to cause the brake fluid, which has flowed out from the secondary chamber 50S of the master cylinder 5 through the brake operation by the driver, to flow into an inside of the positive pressure chamber 601 via the positive pressure oil passage 74, to thereby generate a pedal reaction force. Specifically, when the hydraulic pressure (master cylinder pressure) larger than a predetermined value is applied to a pressure reception surface of the piston 61 in the positive pressure chamber 601, the piston 61 moves toward the back pressure chamber 602 in the axial direction while compressing the spring 64 and the like. On this occasion, the volume of the positive pressure chamber 601 increases, and, simultaneously, the volume of the back pressure chamber 602 decreases. As a result, the brake fluid flows into the positive pressure chamber 601. Simultaneously, the brake fluid flows out from the back pressure chamber 602, and the brake fluid in the back pressure chamber 602 is thus discharged. The back pressure chamber 602 is connected to the back pressure oil passage 16 of the second unit 1B by the back pressure pipe 10X. The brake fluid having flowed out from the back pressure chamber 602 through the brake operation by the driver flows through the back pressure pipe 10X, and is taken into the back pressure oil passage 16 through the back pressure port 874. In other words, the back pressure pipe 10X is a pipe configured to take the brake fluid having flowed out from the back pressure chamber 602 into the back pressure oil passage 16. The stroke simulator 6 is configured to suck the brake fluid from the master cylinder 5 in this way to simulate liquid rigidity of the wheel cylinders W/C, thereby reproducing a sense of stepping on a pedal. When the pressure in the positive pressure chamber 601 falls below the predetermined value, the piston 61 is returned to the initial position by the biasing force (elastic force) of the spring 64 and the like. The damper 66 is configured to come into contact with the retainer member 62, to thereby be deformed elastically when the piston 61 performs a stroke by an amount equal to or more than a predetermined value. As a result, impact is buffered, and pedal feeling thus increases.

Next, detailed description is given of the second unit 1B. The housing 8 is a block having a generally rectangular parallelepiped shape and being made of aluminum alloy as a material. Outer surfaces of the housing 8 include a front surface 801, a rear surface 802, a top surface 803, a bottom surface 804, a right side surface 805 and a left side surface 806. The front surface 801 is a flat surface having a relatively large area. The rear surface 802, is a fiat surface approximately parallel with the front surface 801, and opposes the front surface 801 (across the housing 8). The top surface 803 is a flat surface continuing to the front surface 801 and the rear surface 802. The bottom surface 804 is a flat surface approximately parallel with the top surface 803, and opposes the top surface 803 (across the housing 8). The bottom surface 804 continues to the front surface 801 and the rear surface 802. The right side surface 805 is a flat surface continuing to the front surface 801, the rear surface 802, the top surface 803, and the bottom surface 804. The left side surface 806 is a flat surface approximately parallel with the right side surface 805, and opposes the right side surface 805 (across the housing 8). The left side surface 806 is a flat surface continuing to the front surface 801, the rear surface 802, the top surface 803, and the bottom surface 804. Recessed parts 807 and 808 are formed at corners on the front surface 801 side and the top surface 803 side of the housing 8. In other words, a corner formed of the front surface 801, the top surface 803, and the right side surface 805 and a corner formed of the front surface 801, the top surface 803, and the left side surface 806 have cutoff shapes, and thus have the recessed parts 807 and 808. As viewed in the Y-axis direction, a negative side in the Z-axis direction of the recessed part 807 is approximately orthogonal to an axial center of a cylinder accommodating hole 82E. A negative side in the Z-axis direction of the recessed part 808 is approximately orthogonal to an axial center of a cylinder accommodating hole 82A. Positive sides in the Z-axis direction of the recessed parts 807 and 808 are approximately parallel with the Z-axis direction.

The front surface 801 is formed on the positive side in the Y-axis direction, and extends in parallel with the X axis and the Z axis. The rear surface 802 is formed on the negative side in the Y-axis direction, and extends in parallel with the X axis and the Z axis. The top surface 803 is formed on the positive side in the Z-axis direction, and extends in parallel with the X axis and the Y axis. The bottom surface 804 is formed on the negative side in the Z-axis direction, and extends in parallel with the X axis and the Y axis. The right side surface 805 is formed on the positive side in the X-axis direction, and extends in parallel with the Y axis and the Z axis. The left side surface 806 is formed on the negative side in the X-axis direction, and extends in parallel with the Y axis and the Z axis. In a state in which the second unit 1B is mounted to the vehicle, the Z-axis direction is the vertical direction, and the positive side in the Z-axis direction is the top side in the vertical direction. The X-axis direction is the front/rear direction of the vehicle, and the positive side in the X-axis direction is the vehicle rear side. The Y-axis direction is the lateral direction of the vehicle.

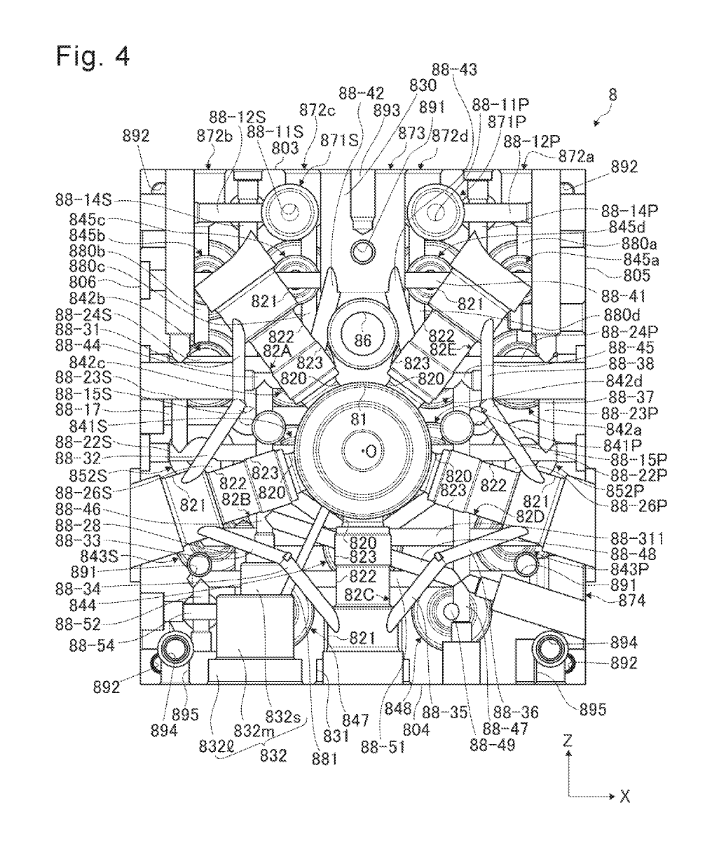

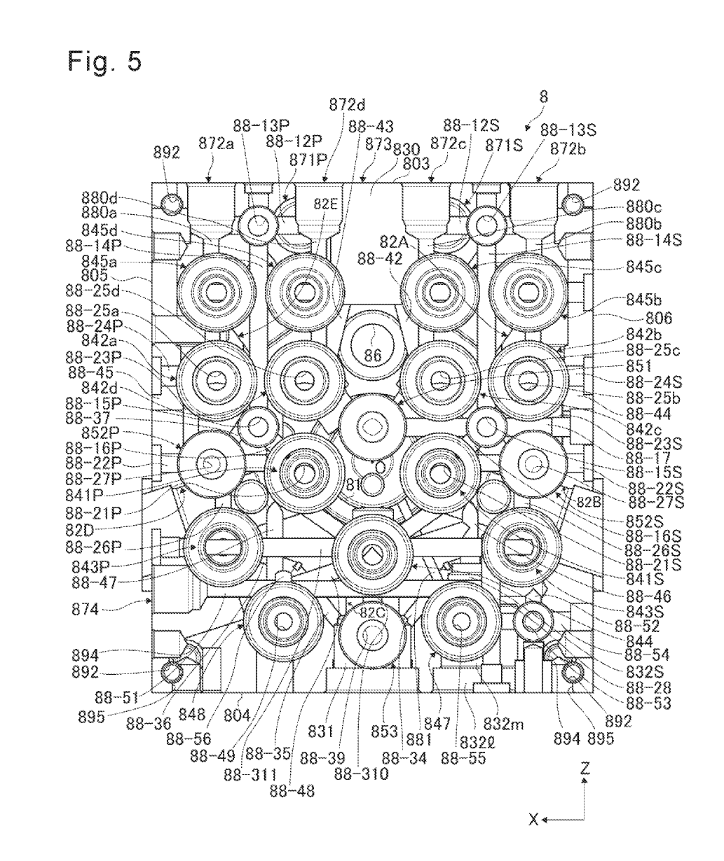

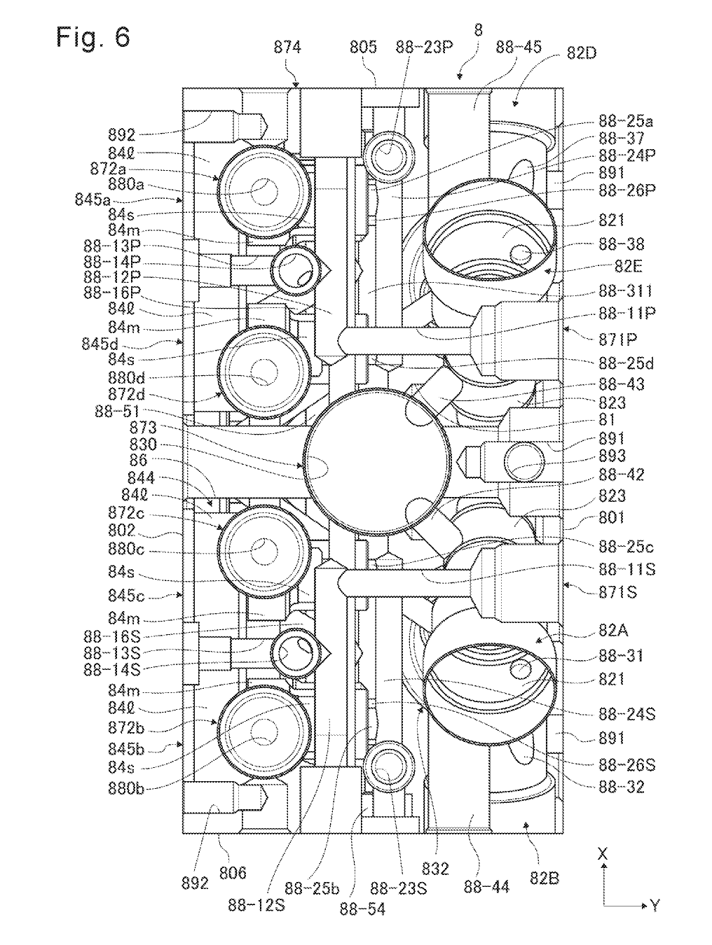

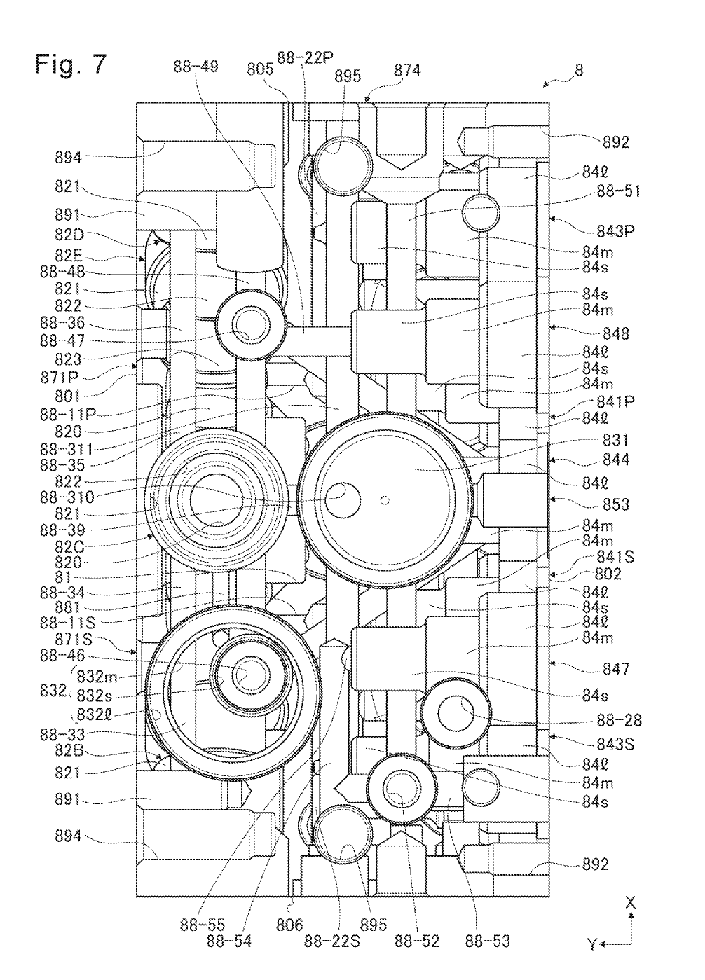

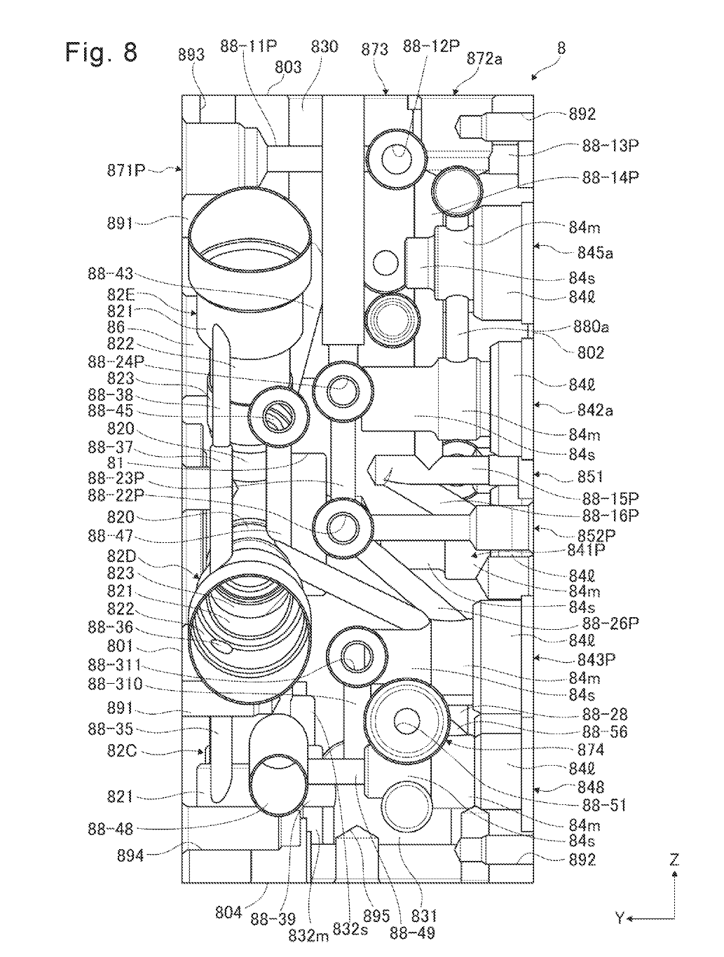

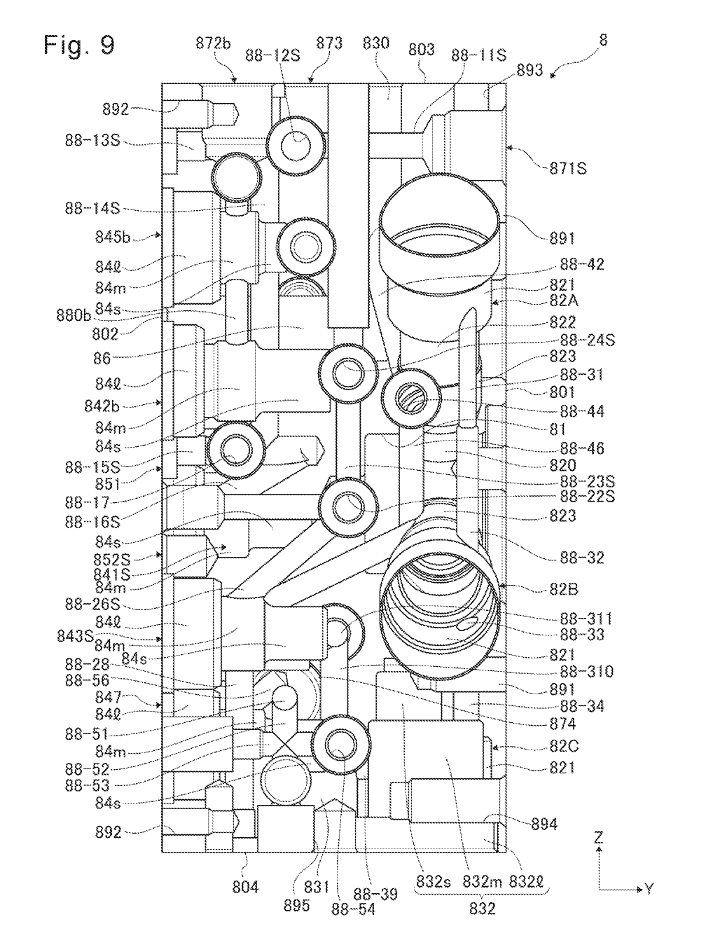

FIG. 4 to FIG. 9 are transparent views for illustrating passages, recessed parts, and holes of the housing 8. FIG. 4 is a front transparent view for illustrating the housing 8 as viewed from the positive side in the Y-axis direction. FIG. 5 is a rear transparent view for illustrating the housing 8 as viewed from the negative side in the Y-axis direction. FIG. 6 is a top transparent view for illustrating the housing 8 as viewed from the positive side in the Z-axis direction. FIG. 7 is a bottom transparent view for illustrating the housing 8 as viewed from the negative side in the Z-axis direction. FIG. 8 is a right side transparent view for illustrating the housing 8 as viewed from the positive side in the X-axis direction. FIG. 9 is a left side transparent view for illustrating the housing 8 as viewed from the negative side in the X-axis direction. The housing 8 includes a cam accommodating hole 81, the plurality of (five) cylinder accommodating holes 82A to 82E, a reservoir chamber 830, a damper chamber 831, a liquid reservoir chamber 832, a plurality of valve body accommodating holes 84, a plurality of sensor accommodating holes 85, a power supply hole 86, a plurality of ports 87, a plurality of oil passage holes 88, and a plurality of bolt holes (pin holes) 89. Those holes and ports are formed by drills or the like. The cam accommodating hole 81 has a bottomed tubular shape extending in the Y-axis direction, and is opened in the front surface 801. An axial center O of the cam accommodating hole 81 is approximately at a center in the X-axis direction on the front surface 801, and is present slightly on the negative side in the Z-axis direction with respect to a center in the Z-axis direction.

The cylinder accommodating hole 82 has a stepped tubular shape, and extends in a radial direction (radiation direction about the axial center O) of the cam accommodating hole 81. The cylinder accommodating hole 82 has a small-diameter part 820 on a side closer to the cam accommodating hole 81, a large-diameter part 821 on a side farther from the cam accommodating hole 81, and a medium-diameter part 822 between the small-diameter part 820 and the large-diameter part 821. A part 823 of the medium-diameter part 822 on the side closer to the cam accommodating hole 81 functions as a suction port and the large-diameter part 821 functions as a discharge port. The cylinder accommodating holes 82 are formed approximately equiangularly (at approximately equal intervals) in a circumferential direction about the axial center O. An angle formed by the axial centers of the cylinder accommodating holes 82 which are adjacent to each other in the circumferential direction of the axial center O is approximately 72° (in a predetermined range including 72°). The plurality of cylinder accommodating holes 82A to 82E are arranged in a single row along the Y-axis direction, and are formed on the positive side in the Y-axis direction of the housing 8. In other words, axial centers of those cylinder accommodating holes 82A to 82E are on the same plane α approximately orthogonal to the axial center O. The plane α is approximately in parallel with the front surface 801 and the rear surface 802 of the housing 8, and is closer to the front surface 801 than to the rear surface 802. The two cylinder accommodating holes 82A and 82E on the positive side in the Z-axis direction are formed on both sides in the X-axis direction with respect to the axial center O The ends on the large diameter part 821 side of the cylinder accommodating holes 82A and 82E are opened in the recessed parts 807 and 808, respectively. The end of the large-diameter part 821 side of the cylinder accommodating hole 82B is opened in the positive side in the Y-axis direction and on the negative side in the Z-axis direction on the left side surface 806. The end of the large-diameter part 821 side of the cylinder accommodating hole 82C is opened approximately at the center in the X-axis direction, and on the positive side in the Y-axis direction on the bottom surface 804. The cylinder accommodating hole 82C extends from the bottom surface 804 to the positive side in the Z-axis direction. The end of the large-diameter part 821 side of the cylinder accommodating hole 82D is opened in the positive side in the Y-axis direction and on the negative side in the Z-axis direction on the right side surface 805. The small-diameter part 820 of each of the cylinder accommodating holes 82 is opened in an inner peripheral surface of the cam accommodating hole 81.

The reservoir chamber 830 has a bottomed tubular shape, which has an axial center extending in the Z-axis direction, and is opened approximately at a center in the X-axis direction and at a center in the Y-axis direction on the top surface 803. The reservoir chamber 830 is arranged in a region surrounded by the master cylinder ports 871 and the wheel cylinder ports 872. (A bottom part on the negative side in the Z-axis direction of) the reservoir chamber 830 is arranged on the positive side in the Z-axis direction with respect to the suction ports 823 of the respective cylinder accommodating holes 82. The reservoir chamber 830 is formed in a region between the cylinder accommodating holes 82A and 82E which are adjacent to each other in the circumferential direction of the axial center O. The cylinder accommodating holes 82A to 82E and the reservoir chamber 830 partially overlap with each other in the Y-axis direction (as viewed in the X-axis direction). The damper chamber 831 has a bottomed tubular shape, which has an axial center extending in the Z-axis direction, and is opened approximately at the center in the X-axis direction and slightly on the negative side in the Y-axis direction with respect to the center in the Y-axis direction on the bottom surface 804. The damper chamber 831 is arranged on the negative side in the Z-axis direction with respect to the cam accommodating hole 81. The liquid reservoir chamber 832 has a stepped bottomed tubular shape, which has an axial center extending in the Z-axis direction, and is opened on the negative side in the X-axis direction and the positive side in the Y-axis direction in the bottom surface 804. The liquid reservoir chamber 832 is arranged on the negative side in the Z-axis direction with respect to the cam accommodating hole 81. The liquid reservoir chamber 832 has a large-diameter part 832l on a side closer to the bottom surface 804 (negative side in the Z-axis direction), a small-diameter part 832s on a side farther from the bottom surface 804 (positive side in the Z-axis direction), and a medium-diameter part 832m between the large-diameter part 832l and the small-diameter part 832s.

Each of the plurality of the valve body accommodating holes 84 has a stepped tubular shape, extends in the Y-axis direction, and is opened in the rear surface 802. The valve body accommodating hole 84 has a large-diameter part 84l on a side closer to the rear surface 802 (negative side in the Y-axis direction), a small-diameter part 84s on a side farther from the rear surface 802 (outer side in the positive side in the Y-axis direction), and a medium-diameter part 84m between the large-diameter part 84l and the small-diameter part 84s. The plurality of valve body accommodating holes 84 are arranged in a single row along the Y-axis direction, and are formed on the negative side in the Y-axis direction of the housing 8. The cylinder accommodating holes 82 and the valve body accommodating holes 84 are arrayed along the Y-axis direction. The plurality of the valve body accommodating holes 84 at least partially overlap with the cylinder accommodating holes 82 as viewed in the Y-axis direction. Most of the plurality of the valve body accommodating holes 84 are contained in a circle connecting the ends on the large-diameter part 821 side (side farther from the axial center O) of the plurality of cylinder accommodating holes 82 to each other. In other words, an outer periphery of this circle and the valve body accommodating holes 84 at least partially overlap with each other.

A valve part of the SOL/V OUT 25 is fitted to an SOL/V OUT accommodating hole 845, and a valve body of the SOL/V OUT 25 is accommodated in the SOL/V OUT accommodating hole 845. The bypass oil passage 120 and the check valve 220 are formed of, for example, a seal member, which has a cup shape and is provided in the hole 842. The SOL/V OUT accommodating holes 845a to 845d are arranged in a single row in the X-axis direction on the positive side in the Z-axis direction of the rear surface 802. The two SOL/V OUT accommodating holes in the P system are formed on the positive side in the X-axis direction. The two SOL/V OUT accommodating holes in the S system are formed on the negative side in the X-axis direction. In the P system, the hole 845a is formed on the positive side in the X-axis direction with respect to the hole 845d. In the S system, the hole 845b is formed on the negative side in the X-axis direction with respect to the hole 845c. A valve part of the SOL/V IN 22 is fined to an SOL/V IN accommodating hole 842, and a valve body of the SOL/V IN 22 is accommodated in the SOL/V IN accommodating hole 842. The SOL/V IN accommodating holes 842a to 842d are arranged in a single row in the X-axis direction slightly on the positive side in the Z-axis direction with respect to the axial center O (or at the center in the Z-axis direction of the housing 8). The SOL/V IN accommodating hole 842 is adjacent to the SOL/V OUT accommodating hole 845 on the negative side in the Z-axis direction. The two SOL/V TN accommodating holes in the P system are formed on the positive side in the X-axis direction. The two SOL/V IN accommodating holes in the S system are formed on the negative side in the X-axis direction. In the P system, the hole 842a is formed on the positive side in the X-axis direction with respect to the hole 842d. In the S system, the hole 842b is formed on the negative side in the X-axis direction with respect to the hole 842c. The axial centers of the holes 842a to 842d are approximately at the same positions in the X-axis direction as the axial centers of the holes 845a to 845d, respectively.

A valve part of the shutoff valve 21 is fitted to a shutoff valve accommodating hole 841, and a valve body of the shutoff valve 21 is accommodated in the shutoff valve accommodating hole 841. The shutoff valve accommodating holes 841P and 841S are arrayed in the X-axis direction slightly on the negative side in the Z-axis direction with respect to the center in the Z-axis direction of the housing 8. The hole 841P is formed slightly on the positive side in the X-axis direction with respect to a center in the X-axis direction. The hole 841S is formed slightly on the negative side in the X-axis direction with respect to the center in the X-axis direction. Axial centers of the holes 841P and 841S are slightly on the negative side in the Z-axis direction with respect to the axial center O, and are at approximately the same positions in the X-axis direction as the axial centers of the holes 842d and 842c. A valve part of the communication valve 23 is fitted to a communication valve accommodating hole 843, and a valve body of the communication valve 23 is accommodated in the communication valve accommodating hole 843. The communication valve accommodating holes 843P and 843S are arrayed in the X-axis direction on the negative side in the Z-axis direction with respect to the axial center O. The communication valve accommodating hole 843 is adjacent to the shutoff valve accommodating hole 841 on the negative side in the Z-axis direction. The hole 843P is formed on the positive side in the X-axis direction with respect to the center in the X-axis direction. The hole 843S is formed on the negative side in the X-axis direction with respect to the center in the X-axis direction. An axial center of the hole 843P is slightly on the negative side in the X-axis direction with respect to the axial center of the hole 842a. An axial center of the hole 843S is slightly on the positive side in the X-axis direction with respect to the axial center of the hole 842b. An end on the positive side in the Z-axis direction of the opening of the communication valve accommodating hole 843 overlaps with an end on the negative side in the Z-axis direction of the opening of the shutoff valve accommodating hole 841, in the Z-axis direction (as viewed in the X-axis direction) on the rear surface 802. A valve part of the pressure regulating valve 24 is fitted to a pressure regulating valve accommodating hole 844, and a valve body of the pressure regulating valve 24 is accommodated in the pressure regulating valve accommodating hole 844. The pressure regulating valve accommodating hole 844 is formed on the negative side in the Z-axis direction with respect to the axial center O, and is formed at approximately the same position in the X-axis direction as the axial center O. The pressure regulating valve accommodating hole 844 is formed between the communication valve accommodating holes 843P and 843S in the X-axis direction, and is adjacent to the shutoff valve accommodating holes 841 on the negative side in the Z-axis direction. The pressure regulating valve accommodating hole 844 is at approximately the same position in the Z-axis direction as the communication valve accommodating holes 843, and is arrayed together with the holes 843P and 843S in a single row in the X-axis direction. Both ends in the X-axis direction of the opening of the pressure regulating valve accommodating hole 844 overlap with ends in the X-axis direction of the openings of the shutoff valve accommodating holes 841, in the X-axis direction (as viewed in the Z-axis direction) on the rear surface 802.

A valve part of the SS/V IN 27 is fitted to an SS/V IN accommodating hole 847, and a valve body of the SS/V IN 27 is accommodated in the SS/V IN accommodating hole 847. The bypass oil passage 170 and the check valve 270 are each formed of, for example, a seal member, which has a cup shape and is provided in the hole 847. A valve part of the SS/V OUT 28 is fitted to an SS/V OUT accommodating hole 848, and a valve body of the SS/V OUT 28 is accommodated in the SS/V OUT accommodating hole 848. The bypass oil passage 180 and the check valve 280 are formed of a seal member, which has a cup shape and is provided in the hole 848. The holes 847 and 848 are arrayed in the X-axis direction on the negative side in the Z-axis direction with respect to the axial center O. The holes 847 and 848 are adjacent to the communication valve accommodating holes 843 and the pressure regulating valve accommodating holes 844 on the negative side in the Z-axis direction. An axial center of the hole 848 is positioned between the axial center of the hole 844 and the axial center of the hole 843P in the X-axis direction, and is positioned slightly on the positive side in the X-axis direction with respect to an axial center of the hole 841P. An end on the positive side in the X-axis direction of the opening of the hole 848 overlaps with an end on the negative side in the X-axis direction of the opening of the hole 843P, in the X-axis direction (as viewed in the Z-axis direction) on the rear surface 802. An end on the positive side in the Z-axis direction of the opening of the hole 848 overlaps with an end on the negative side in the Z-axis direction of the opening of the hole 843P, in the Z-axis direction (as viewed in the Y-axis direction). An axial center of the hole 847 is positioned between the axial center of the hole 844 and the axial center of the hole 843S in the X-axis direction, and is positioned slightly on the negative side in the X-axis direction with respect to an axial center of the hole 841S. An end on the negative side in the X-axis direction of the opening of the hole 847 overlaps with an end on the positive side in the X-axis direction of the opening of the hole 843S, in the X-axis direction (as viewed in the Z-axis direction) on the rear surface 802. An end on the positive side in the Z-axis direction of the opening of the hole 847 overlaps with an end on the negative side in the Z-axis direction of the opening of the hole 843S, in the Z-axis direction (as viewed in the Y-axis direction)

Each of a plurality of sensor accommodating holes 85 has a bottomed tubular shape, which has an axial center extending in the Y-axis direction, and is opened in the rear surface 802. A pressure sensitive part of the master cylinder pressure sensor 91 is accommodated in a master cylinder pressure sensor accommodating hole 851. The hole 851 is formed at approximately at the center in the X-axis direction and approximately at the center in the Z-axis direction of the housing 8, and an axial center of the hole 851 is slightly on the positive side in the Z-axis direction with respect to the axial center O. The holes 851 are formed in a region surrounded by the holes 842, 845, 841P, and 841S. A pressure sensitive part of the discharge pressure sensor 93 is accommodated in a discharge pressure sensor accommodating hole 853. The hole 853 is formed approximately at the center in the X-axis direction and on the negative side in the Z-axis direction of the housing 8, and an axial center of the hole 853 is slightly on the negative side in the Z-axis direction with respect to the holes 847 and 848. The hole 853 is formed in a region surrounded by the holes 844, 847, and 848. A pressure sensitive part of the wheel cylinder pressure sensor 92 is accommodated in a wheel cylinder pressure sensor accommodating hole 852. The holes 852P and 852S are arrayed in the X-axis direction at approximately the same positions in the Z-axis direction as the axial center O. The hole 852E is formed on the positive side in the X-axis direction with respect to the center in the X-axis direction. The hole 852S is formed on the negative side in the X-axis direction with respect to the center in the X-axis direction. An axial center of the hole 852P is slightly on the positive side in the X-axis direction with respect to the axial center of the hole 842a. An axial center of the hole 852S is slightly on the negative side in the X-axis direction with respect to the axial center of the hole 842b. The hole 852 is formed in a region surrounded by the holes 841, 842, and 843. The power supply hole 86 has a tubular shape, and passes through the housing 8 (between the front surface 801 and the rear surface 802) in the Y-axis direction. The hole 86 is formed approximately at the center in the X-axis direction and on the positive side in the Z-axis direction of the housing 8. The hole 86 is arranged (formed) in a region surrounded by the holes 842c and 842d and the holes 845c and 845d, and in a region between the cylinder accommodating holes 82A and 82E which are adjacent to each other.

Each of the master cylinder ports 871 has a bottomed tubular shape, which has an axial center extending in the Y-axis direction, and is opened in a portion at an end on the positive side in the Z-axis direction between the recessed parts 807 and 808 on the front surface 801. A primary port 871P is formed on the positive side in the X-axis direction. The secondary port 871S is formed on the negative side in the X-axis direction. Both the ports 871P and 871S are arrayed in the X-axis direction, and are on both sides of the reservoir chamber 830 and a bolt hole 891 in the X-axis direction (as viewed in the Y-axis direction) The ports 871P and 871S are formed respectively between the reservoir chamber 830 and the cylinder accommodating holes 82A and 82E in the circumferential direction of the axial center O (as viewed in the Y-axis direction). Openings of the master cylinder ports 871 and an opening of the bolt hole 891 partially overlap with each other in the Z-axis direction (as viewed in the X-axis direction). Each of the wheel cylinder ports 872 has a bottomed tubular shape, which has an axial center extending in the Z-axis direction, and is opened on the negative side in the Y-axis direction (position closer to the rear surface 802 than to the front surface 801) in the top surface 803. The ports 872a to 872d are arranged in a single row in the X-axis direction. The two ports in the P system are formed on the positive side in the X-axis direction. The two ports in the S system are formed on the negative side in the X-axis direction. In the P system, the port 872a is formed on the positive side in the X-axis direction with respect to the port 872d. In the S system, the port 872b is formed on the negative side in the X-axis direction with respect to the port 872c. The ports 872c and 872d are on both sides of the suction port 873 (reservoir chamber 830) as viewed in the Y-axis direction. An opening of each of the ports 872 and the suction port 873 (opening of the reservoir chamber 830) partially overlap with each other in the X-axis direction (as viewed in the Y-axis direction). The opening of each of the ports 872 and an opening of the suction port 873 partially overlap with each other in the Y-axis direction (as viewed in the X-axis direction).

The suction port 873 is the opening of the reservoir chamber 830 on the top surface 803, is formed so as to be directed to the top side in the vertical direction, and is opened on the top side in the vertical direction. The port 873 is opened at a position on a center side in the X-axis direction and on a center side in the Y-axis direction closer to the front surface 801 than the wheel cylinder ports 872, on the top surface 803. The port 873 is formed on the positive side in the Z-axis direction with respect to the suction ports 823 of the cylinder accommodating holes 82A to 82E. The cylinder accommodating holes 82A and 82E are on both sides of the port 873 as viewed in the Y-axis direction. An opening of each of the cylinder accommodating holes 82A and 82E and the port 873 partially overlap with each other in the Y-axis direction (as viewed in the X-axis direction). The back pressure port 874 has a bottomed tubular shape, which has an axial center extending in the X-axis direction, and is opened slightly on the negative side in the Y-axis direction and on the negative side in the Z-axis direction with respect to the axial center O on the right side surface 805. The axial center of the port 874 is positioned between an axial center of the communication valve accommodating hole 843 and an axial center of the SS/V OUT accommodating hole 848 in the Z-axis direction.

The plurality of oil holes 88 include first to fifth hole groups 88-1 to 88-5 and oil passage holes 880 and 881. The first hole group 88-1 connects the master cylinder ports 871, the shutoff valve accommodating holes 841, and the master cylinder pressure sensor accommodating hole 851 to one another. The second hole group 88-2 connects the shutoff valve accommodating holes 841, the communication valve accommodating holes 843, the SOL/V IN accommodating holes 842, the SS/V IN accommodating hole 847, and the wheel cylinder pressure sensor accommodating holes 852 to one another. The third hole group 88-3 connects the discharge ports 821 of the cylinder accommodating holes 82, the communication valve accommodating holes 843, the pressure regulating valve accommodating holes 844, and the discharge pressure sensor accommodating hole 853 to one another. The fourth hole group 88-4 connects the reservoir chamber 830, the suction ports 823 of the cylinder accommodating holes 82, the SOL/V OUT accommodating holes 845, the SS/V OUT accommodating hole 848, and the pressure regulating valve accommodating hole 844 to one another. The fifth hole group 88-5 connects the back pressure port 874, the SS/V IN accommodating hole 847, and the SS/V OUT accommodating hole 848 to one another. Each of the oil holes 880 connects the SOL/V IN accommodating hole 842 and the wheel cylinder port 872 to each other. The oil passage hole 881 connects the cam accommodating hole 81 and the liquid reservoir chamber 832 to each other.

The first hole group 88-1 includes first holes 88-11 to seventh holes 88-17. First, description is given of the P system. The first hole 88-11P extends from a bottom part of the primary port 871P to the negative side in the Y-axis direction. The second hole 88-12P extends from the right side surface 805 to the negative side in the X-axis direction, and is connected to the first hole 88-11P. The third hole 88-13P extends from the rear surface 802 to the positive side in the Y-axis direction, and is connected to the second hole 88-12P. The fourth hole 88-14P extends from the positive side in the Y-axis direction of the third hole 88-13P to the negative side in the Z-axis direction. The fifth hole 88-15P extends from the rear surface 802 to the positive side in the Y-axis direction, and is connected to the fourth hole 88-14P. The sixth hole 88-16P extends from an end on the positive side in the Y-axis direction of the fifth hole 88-15P to the positive side in the X-axis direction, the negative side in the Y-axis direction, and the negative side in the Z-axis direction, and is connected to the medium-diameter part 84m of the shutoff valve accommodating hole 841P. The seventh hole 88-17 extends from the left side surface 806 to the positive side in the X-axis direction, is connected to the fifth hole 88-15P, and is connected to the master cylinder pressure sensor accommodating hole 851. The S system is symmetrical with the P system about the center in the X-axis direction of the housing 8 except that the seventh hole 88-17 is not included.

The second hole group 88-2 includes first holes 88-21 to seventh holes 88-27. First, description is given of the P system. The first hole 88-21P extends over a short distance from a bottom part of the shutoff valve accommodating holes 841 to the positive side in the Y-axis direction. The second hole 88-22P extends from the right side surface 805 to the negative side in the X-axis direction, and is connected to the first hole 88-21P. The third hole 88-23P extends from the top surface 803 to the negative side in the Z-axis direction, and is connected to the second hole 88-22P on the positive side in the X-axis direction. The fourth hole 88-24P extends from the right side surface 805 to the negative side in the X-axis direction, and is connected to an intermediate portion of the third hole 88-23P. The fifth holes 88-25a and 88-25d extend over short distances from the positive side in the X-axis direction of the fourth hole 88-24P to the positive side in the Y-axis direction, and are connected to bottom parts of the SOL/V IN accommodating holes 842a and 842d, respectively. The sixth hole 88-26P extends from an intermediate portion of the second hole 88-22P to the negative side in the Y-axis direction and the negative side in the Z-axis direction, and is connected to the medium-diameter part 84m of the communication valve accommodating hole 843P. The seventh hole 88-27P extends from a bottom part of the wheel cylinder pressure sensor accommodating hole 852P to the positive side in the Y-axis direction, and is connected to an intermediate portion of the second hole 88-22P. The S system is symmetrical with the P system about the center in the X-axis direction of the housing 8 except that the eighth hole 88-28 is included. The eighth hole 88-28 extends from the negative side in the X-axis direction of the bottom surface 804 to the positive side in the Z-axis direction, is connected to the medium-diameter part 84m of the SS/V IN accommodating hole 847, and is connected to the medium-diameter part 84m of the communication valve accommodating hole 843S.

The third hole group 88-3 includes a first hole 88-31 to a twelfth hole 88-312. The first hole 88-31 extends from the discharge port 821 of the cylinder accommodating hole 82A to the negative side in the Z-axis direction. The second hole 88-32 extends from an end of the first hole 88-31 to the negative side in the X-axis direction and the negative side in the Z-axis direction, and is connected to the discharge port 821 of the cylinder accommodating hole 82B. The third hole 88-33 extends from the discharge port 821 of the cylinder accommodating hole 82B to the positive side in the X-axis direction and the negative side in the Z-axis direction. The fourth hole 88-34 extends from an end of the third hole 88-33 to the positive side in the X-axis direction and the negative side in the Z-axis direction, and is connected to the discharge port 821 of the cylinder accommodating hole 82C. The fifth hole 88-35 extends from the discharge port 821 of the cylinder accommodating hole 82C to the positive side in the X-axis direction and the positive side in the Z-axis direction. The sixth hole 88-36 extends from an end of the fifth hole 88-35 to the positive side in the X-axis direction and the positive side in the Z-axis direction, and is connected to the discharge port 821 of the cylinder accommodating hole 82D. The seventh hole 88-37 extends from the discharge port 821 of the cylinder accommodating hole 82D to the negative side in the X-axis direction and the positive side in the Z-axis direction. The eighth hole 88-38 extends from an end of the seventh hole 88-37 to the positive side in the Z-axis direction, and is connected to the discharge port 821 of the cylinder accommodating hole 82E. The ninth hole 88-39 extends from a bottom part of the discharge pressure sensor accommodating hole 853 to the positive side in the Y-axis direction, is connected to the damper chamber 831, and is connected to the discharge port 821 of the cylinder accommodating hole 82C. The tenth hole 88-310 extends from a bottom part of the damper chamber 831 to the positive side in the Z-axis direction. The eleventh hole 88-311 extends from the right side surface 805 to the negative side in the X-axis direction, is connected to bottom parts of both of the communication valve accommodating holes 843, and is connected to an end of the tenth hole 88-310. The twelfth hole 88-312 (not shown) extends over a short distance from a bottom part of the pressure regulating valve accommodating hole 844 to the positive side in the Y-axis direction, and is connected to the eleventh hole 88-311.

The fourth hole group 88-4 includes a first hole 88-41 to a ninth hole 88-49. The first hole 88-41 extends from the left side surface 806 to the positive side in the X-axis direction, is connected to a bottom part of the reservoir chamber 830, and is connected to bottom parts of the SOL/V OUT accommodating holes 845. The second hole 88-42 extends from the bottom part of the reservoir chamber 830 to the positive side in the X-axis direction, the positive side in the Y-axis direction, and the negative side in the Z-axis direction, and is connected to the suction port 823 of the cylinder accommodating hole 82A. The third hole 88-43 extends from the bottom part of the reservoir chamber 830 to the positive side in the X-axis direction, the positive side in the Y-axis direction, and the negative side in the Z-axis direction, and is connected to the suction port 823 of the cylinder accommodating hole 82E. The fourth hole 88-44 extends from froth the left side surface 806 to the positive side in the X-axis direction, and is connected to the suction port 823 of the cylinder accommodating hole 82A. The fifth hole 88-45 extends from the right side surface 805 to the negative side in the X-axis direction, and is connected to the suction port 823 of the cylinder accommodating hole 82E. The sixth hole 88-46 extends from a bottom part of the liquid reservoir chamber 832 to the positive side in the Z-axis direction, is connected to the suction port 823 of the cylinder accommodating hole 82B, and is connected to an intermediate portion of the fourth hole 88-44. The seventh hole 88-47 extends from the bottom surface 804 to the positive side in the Z-axis direction, is connected to the suction port 823 of the cylinder accommodating hole 82D, and is connected to an intermediate portion of the fifth hole 88-45. The eighth hole 88-48 extends from the right side surface 805 to the negative side in the X-axis direction and the positive side in the Z-axis direction, is connected to the suction port 823 of the cylinder accommodating hole 82C, and is connected to an intermediate portion of the sixth hole 88-46 and an intermediate portion of the seventh hole 88-47. The ninth hole 88-49 extends from a bottom part of the SS/V OUT accommodating hole 848 to the positive side in the Y-axis direction, and is connected to an intermediate portion of the seventh hole 88-47.

The fifth hole group 88-5 includes a first hole 88-51 to a sixth hole 88-56. The first hole 88-51 extends from a bottom part of the back pressure port 874 to the negative side in the X-axis direction. The second hole 88-52 extends from an end of the first hole 88-51 to the negative side in the Z-axis direction. The third hole 88-53 extends from the rear surface 802 to the positive side in the Y-axis direction. The third hole 88-53 is connected to the second hole 88-52 in the course. The fourth hole 88-54 extends from the left surface 806 to the positive side in the X-axis direction. An end of the third hole 88-53 is connected to an intermediate portion of the fourth hole 88-54. The fifth hole 88-55 extends from an end of the fourth hole 88-54 to the negative side in the Y-axis direction over a short distance, and is connected to a bottom part of the SS/V IN accommodating hole 847. The sixth hole 88-56 extends from an intermediate portion of the first hole 88-51 to the negative side in the Y-axis direction and the negative side in the Z-axis direction over a short distance, and is connected to the medium-diameter part 84m of the SS/V OUT accommodating hole 848. Each of the holes 880 extends from a bottom part of the wheel cylinder port 872 to the negative side in the Z-axis direction, is connected to the medium-diameter part 84m of the SOL/V OUT accommodating hole 845, and is connected to the medium-diameter part 84m of the SOL/V IN accommodating hole 842. The hole 881 extends from the cam accommodating hole 81 to the negative side in the X-axis direction and the negative side in the Z-axis direction, and is connected to the medium-diameter part 832m of the liquid reservoir chamber 832.

The first hole 88-11 to the sixth hole 88-16P of the first hole group 88-1 connect the master cylinder ports 871 and the shutoff valve accommodating holes 841 to each other, and function as a part of the supply oil passages 11. The first hole 88-21 to the fifth hole 88-25 of the second hole group 88-2 connect the shutoff valve accommodating holes 841 and the SOL/V IN accommodating holes 842 to each other, and function as a part of the supply oil passages 11. The sixth hole 88-26P connects the communication valve accommodating hole 843 and the second hole 88-22P to each other, and functions as a part of the discharge oil passage 13. The eighth hole 88-28 connects the SS/V IN accommodating hole 847 and the communication valve accommodating hole 843S to each other, and functions as a part of the first simulator oil passage 17. Each of the holes 880 connects the SOL/V IN accommodating hole 842 and the wheel cylinder port 872 to each other, and functions as a part of the supply oil passage 11. Moreover, each of the holes 880 connects the SOL/V IN accommodating hole 842 and the SOL/V OUT accommodating hole 845 to each other, and functions as a part of the pressure reducing oil passage 15. The first hole 88-31 to the eleventh hole 88-311 of the third hole group 88-3 connect the discharge ports 821 of the cylinder accommodating holes 82 and the communication valve accommodating holes 843 to each other, and function as a part of the discharge oil passages 13. The twelfth hole 88-312 connects the eleventh hole 88-311 and the pressure regulating valve accommodating hole 844 to each other, and functions as a part of the pressure regulating oil passage 14. The first hole 88-41 of the fourth hole group 88-4 connects the SOL/V OUT accommodating hole 845 and the reservoir chamber 830 to each other, and functions as a part of the pressure reducing oil passage 15. The second hole 88-42 to the eighth hole 88-48 connect the reservoir chamber 830 and the suction ports 823 of the cylinder accommodating holes 82 to each other, and function as the suction oil passage 12. The ninth hole 88-49 connects the SS/V OUT accommodating hole 848 and the seventh hole 88-47 to each other, and functions as the second simulator oil passage 18. The first hole 88-51 to the fifth hole 88-55 of the fifth hole group 88-5 connect the back pressure port 874 and the SS/V IN accommodating hole 847 to each other, and function as a part of the back pressure oil passage 16 and the first simulator oil passages 17. The sixth hole 88-56 connects the first hole 88-51 and the SS/V OUT accommodating hole 848 to each other, and functions as a part of the second simulator oil passage 18. The hole 881 connects the cam accommodating hole 81 and the liquid reservoir chamber 832 to each other, and serves as a drain oil passage.

A plurality of bolt holes 89 include bolt holes 891 to 895. The bolt hole 891 has a bottomed tubular shape, which has an axial center extending in the Y-axis direction, and is opened in the front surface 801. Three holes 891 are formed at positions approximately symmetrical with respect to the axial center O of the cam accommodating hole 81. Distances from the axial center O to the respective holes 891 are approximately the same. One hole 891 is formed approximately at the center in the X-axis direction (position overlapping with the axial center O in the X-axis direction) and on the positive side in the Z-axis direction with respect to the axial center O in the front surface 801. This hole 891 is positioned between the master cylinder ports 871P and 871S in the X-axis direction, and overlaps with the reservoir chamber 830 as viewed in the Y-axis direction. The other two holes 891 are on both sides in the X-axis direction with respect to the axial center O, and on the negative side in the Z-axis direction with respect to the axial center O. The bolt hole 892 has a bottomed tubular shape, which has an axial center extending in the Y-axis direction, and is opened in the rear surface 802. A total of four holes 892 are formed at four corners of the rear surface 802, respectively. The bolt hole 893 has a bottomed tubular shape, which has an axial center extending in the Z-axis direction, and is opened in the top surface 803. One hole 893 is formed approximately at the center in the X-axis direction (position overlapping with the axial center O in the X-axis direction) on the positive side in the Y-axis direction in the top surface 803. The bolt hole 894 has a bottomed tubular shape, which has an axial center extending in the Y-axis direction, and is opened in the front surface 801. Two holes 894 are formed on the negative side in the Z-axis direction with respect to the axial center O and at both ends in the X-axis direction in the front surface 801. The holes 894 are positioned on an opposite side of the master cylinder port 871 with respect to the axial center O. The hole 894 on the negative side in the X-axis direction is approximately on the opposite side of the primary port 871P with respect to the axial center O. The hole 894 on the positive side in the X-axis direction is approximately on the opposite side of the secondary port 871S with respect to the axial center O. The axial centers of the holes 894 are arranged on the negative side in the Z-axis direction with respect to the axial centers of the bolt holes 891 on the negative side in the Z-axis direction, and on sides (outer sides) closer to the side surfaces 805 and 806 in the X-axis direction. The bolt hole 895 has a bottomed tubular shape, which has an axial center extending in the Z-axis direction. Two bolt holes 895 are provided, and are opened approximately at the center in the Y-axis direction, and on both ends in the X-axis direction on the bottom surface 804. An end on the positive side in the Z-axis direction of the hole 895 overlaps with the bolt hole 894 as viewed in the Y-axis direction.

(Mount Fixation)

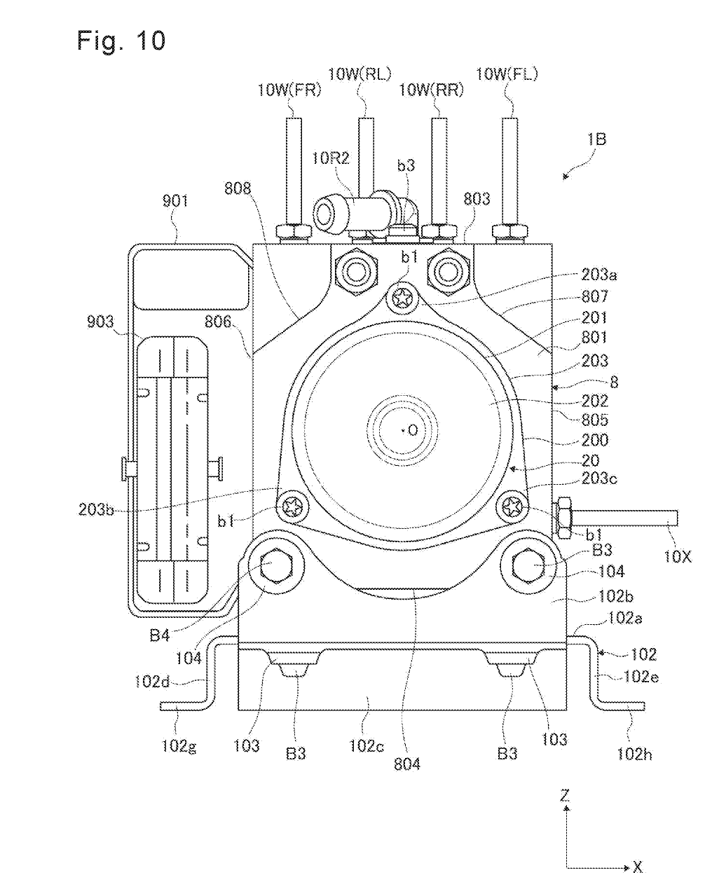

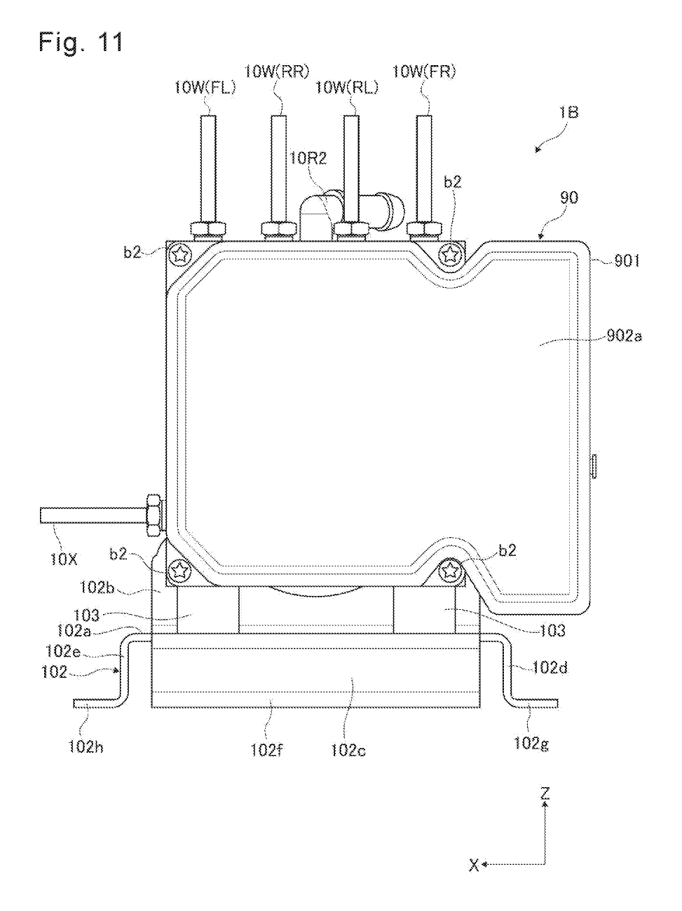

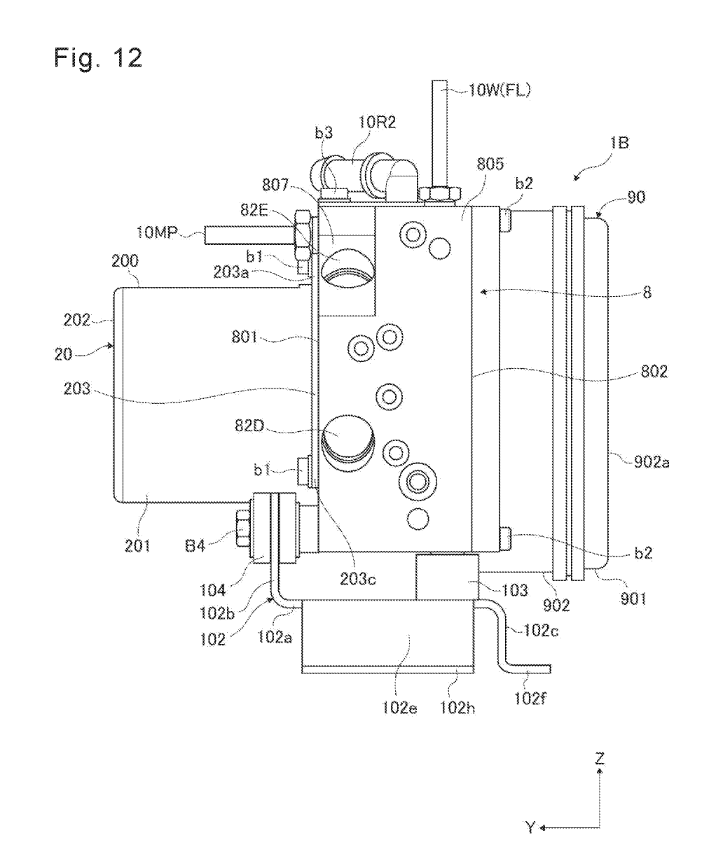

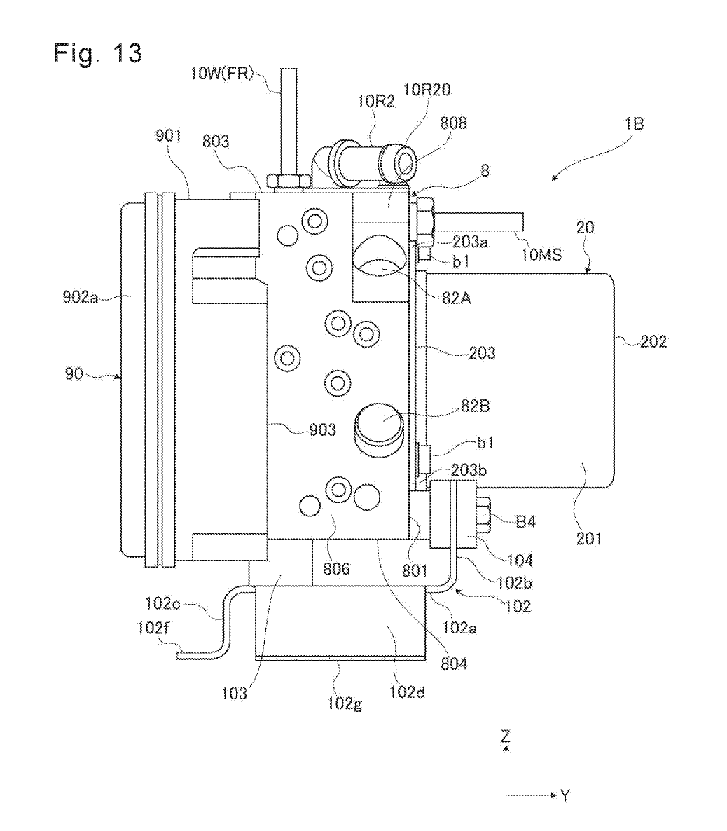

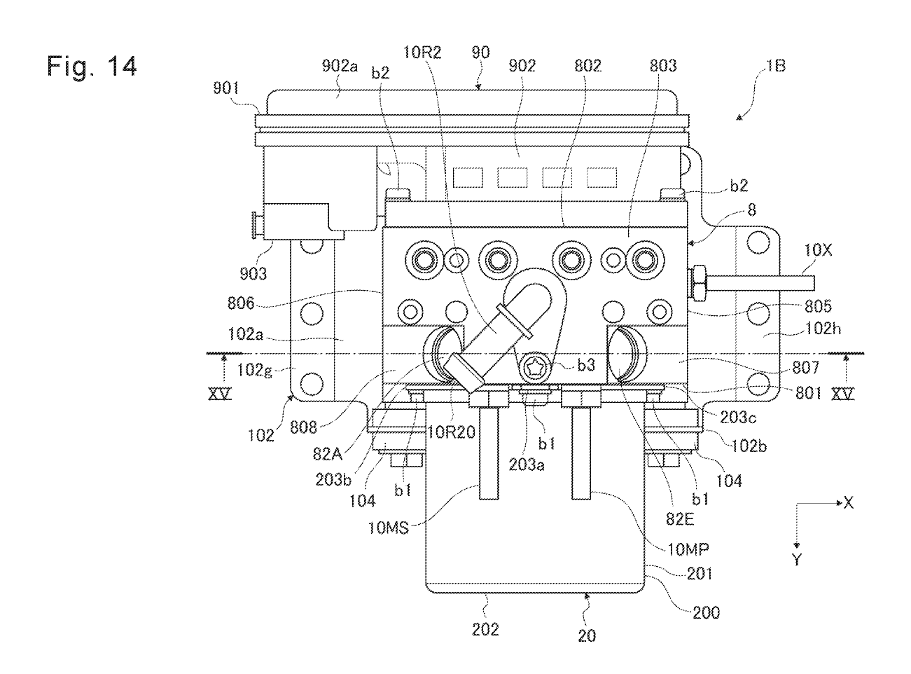

FIG. 10 is a front view for illustrating the second unit 1B as viewed from the positive side in the Y-axis direction. FIG. 11 is a rear view for illustrating the second unit 1B as viewed from the negative side in the Y-axis direction. FIG. 12 is a right side view for illustrating the second unit 1B as viewed from the positive side in the X-axis direction. FIG. 13 is a left side view of the second unit 1B as viewed from the negative side in the X-axis direction. FIG. 14 is a top view for illustrating the second unit 1B as viewed from the positive side in the Z-axis direction. A mount 102 is a pedestal formed by bending a metal plate, and is fixed by fastening bolts to the vehicle body side (a bottom surface of the motor room). The mount 102 integrally includes a first mount part 102a, a second mount part 102b, and leg parts 102c to 102b The first mount part 102a is arranged approximately in parallel with the X axis and the Y axis. Bolt holes are formed at an end on the negative side in the Y-axis direction at ends on both sides in the X-axis direction of the first mount part 102a. Bolts B3 are inserted into those bolt holes from the negative side in the Z-axis direction. The second mount part 102b extends from an end on the positive side in the Y-axis direction of the first mount part 102a to the positive side in the Z-axis direction. An end on the positive side in the Z-axis direction of the second mount part 102b curves to form a recessed shape along a tubular part 201 of a motor housing 200. Bolt holes are formed at an end on the positive side in the Z-axis direction at ends on both sides in the X-axis direction of the second mount part 102b. Bolts B4 are inserted into those bolt holes from the positive side in the Y-axis direction.

The leg part 102c extends from an end on the negative side in the Y-axis direction of the first mount part 102a to the negative side in the Z-axis direction. The leg part 102d extends from an end on the negative side in the X-axis direction of the first mount part 102a to the negative side in the Z-axis direction. The leg part 102e extends from an end on the positive side in the X-axis direction of the first mount part 102a to the negative side in the Z-axis direction. The leg part 102f extends from an end on the negative side in the Z-axis direction of the leg part 102c to the negative side in the Y-axis direction. A plurality of bolt holes are arranged in a row in the X-axis direction in the leg part 102f. Bolts configured to fix the mount 102 to the vehicle body side are inserted into those bolt holes from the positive side in the Z-axis direction. The leg part 102g extends from an end on the negative side in the Z-axis direction of the leg part 102d to the negative side in the X-axis direction. A plurality of bolt holes are arranged in a row in the Y-axis direction in the leg part 102g. Bolts configured to fix the mount 102 to the vehicle body side are inserted into those bolt holes from the positive side in the Z-axis direction. The leg part 102h extends from an end on the negative side in the Z-axis direction of the leg part 102e to the positive side in the X-axis direction. A plurality of bolt holes are arranged in a row in the Y-axis direction in the leg part 102h. Bolts configured to fix the mount 102 to the vehicle body side are inserted into those bolt holes from the positive side in the Z-axis direction. The bolts B3 of the first mount part 102a are inserted into the bolt holes 895 of the housing 8, and are fixed. The bolts B3 are configured to fix the bottom surface 804 of the housing 8 to the first mount part 102a via an insulator 103. The bolts B4 of the second mount part 102b are inserted into the bolt holes 894 of the housing 8, and are fixed. The bolts B4 are configured to fix the front surface 801 of the housing 8 to the second mount part 102b via an insulator 104. The bolt holes 894 and 895 function as fixing holes (fixing parts) for fixing the housing 8 to the vehicle body side (mount 102). The insulators 103 and 104 are elastic members configured to suppress (insulate) vibration.

(Port Connection)

Each of the ports 871 to 874 continues to the oil passage inside the housing 8, and connects the oil passage inside and an oil passage (pipe 10M or the like) outside the housing 8 to each other. The master cylinder ports 871 are ports configured to connect the housing 8 (second unit 1B) to the master cylinder 5 (hydraulic pressure chambers 50). The master cylinder ports 871 are connected to the supply oil passages 11 inside the housing 8, and are connected to (the pipes 10M from) the master cylinder 5 outside the housing 8. The master cylinder ports 871 are formed on the positive side in the Z-axis direction (the top side in the vertical direction) with respect to the axial center O, and on the positive side in the Z-axis direction of the motor 20 (motor housing 200). The other end of the primary pipe 10MP is fixedly provided in the primary port 871P (the primary pipe 10MP is mounted and connected). The other end of the secondary pipe 10MS is fixedly provided in the secondary port 871S (the secondary pipe 10MS is mounted and connected). The wheel cylinder ports 872 are ports configured to connect the housing 8 (second unit 1B) to the wheel cylinders W/C. The wheel cylinder ports 872 are connected to the supply oil passages 11 inside the housing 8, and are connected to (the pipes 10W from) the wheel cylinders W/C outside the housing 8. The other end of each of the wheel cylinder pipes 10W is fixedly provided in each of the wheel cylinder ports 872 (the wheel cylinder pipe 10W is mounted and connected).

The suction port 873 is a port (connection port) configured to connect the housing 8 (second unit 1B) to the reservoir tank 4. The suction port 873 is connected to the reservoir chamber 830 inside the housing 8, and are connected to (the pipe 10R from) the reservoir tank 4 outside the housing 8. The nipple 10R2 is fixedly provided in the suction port 873, and the other end of the suction pipe 10R is connected to the nipple 10R2. The bolt hole 893 functions as a fixing hole (fixing part) for fixing the nipple 10R2 to the housing 8. The back pressure port 874 is a port configured to connect the housing 8 (second unit 1B) to the stroke simulator 6 (back pressure chamber 602). The back pressure port 874 is connected to the back pressure oil passage 16 inside the housing 8, and is connected to (the pipe 10X from) the stroke simulator 6 outside the housing 8. The other end of the back pressure pipe 10X is fixedly provided in the back pressure port 874 (the back pressure pipe 10X is mounted and connected).

(Motor Fixation)

The motor 20 is arranged on the front surface 801 of the housing 8, and the motor housing 200 is mounted thereto. The front surface 801 functions as a motor mounting surface. The bolt holes 891 function as fixing holes (fixing parts) configured to fix the motor 20 to the housing 8. The motor 20 includes the motor housing 200. The motor housing 200 has a bottomed tubular shape, and includes a tubular part 201, a bottom part 202, and a flange part 203. The tubular part 201 accommodates a stator, a rotor, and the like on its inner peripheral side. A rotation shaft of the motor 20 extends on an axial center of the tubular part 201. The bottom part 202 closes one side in the axial direction of the tubular part 201. The flange part 203 is provided at an end on the other side (opening side) in the axial direction of the tubular part 201, and extends from an outer peripheral surface of the tubular part 201 to a radially outer side. The flange part 203 includes first, second, and third protruded parts 203a, 203b, and 203c. A bolt hole passes through each of the protruded parts 203a to 203c. A bolt b1 is inserted into each of the bolt holes. The bolt b1 is fastened to the bolt hole 891 of the housing 8. The flange part 203 is fastened to the front surface 801 with bolts b1. Conductive members (power supply connector) for current supply is connected to the stator. The conductive members are integrated together with wires configured to transmit a detection signal of a resolver. The conductive members extending from the stator are accommodated (mounted) in the power supply hole 86, and protrude from the rear surface 802 to the negative side in the Y-axis direction. The power supply hole 86 functions as a mounting hole in which the conductive members are mounted.

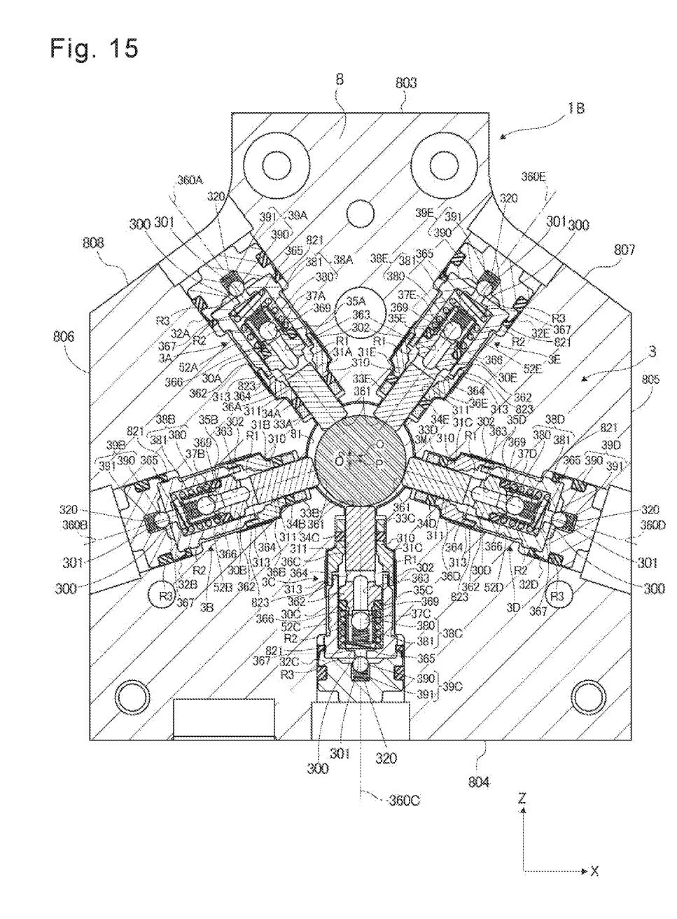

FIG. 15 is a cross-sectional view for illustrating the second unit 1B taken along the plane α, and is a cross-sectional view as viewed in a direction indicated by XV-XV of FIG. 14. The axial center (axis) of the rotation shaft of the motor 20 approximately matches the axial center O of the cam accommodating hole 81. A pump rotation shaft and a cam unit 3M are accommodated in the cam accommodating hole 81. The pump rotation shaft is a drive shaft of the pump 3. The pump rotation shaft is fixed to the rotation shaft of the motor 20 so that the axial center thereof extends on an extension of the axial center of the rotation shaft of the motor 20, and is rotationally driven by the motor 20. The axial center of the pump rotation shaft approximately matches the axial center O. The pump rotation shaft rotates integrally with the rotation shaft of the motor 20 about the axial center O. The cam unit 3M is provided on the pump rotation shaft. The cam unit 3M includes a drive member and a plurality of rolling elements. Detailed description of the cam unit 3M is omitted in FIG. 15. The cam is an eccentric cam having a cylindrical shape, and has an axial center P eccentric with respect to the axial center O of the pump rotation shaft. The axial center P extends approximately in parallel with the axial center O. The cam oscillates while rotating about the axial center O integrally with the pump rotation shaft. The drive member has a tubular shape, and is arranged on an outer peripheral side of the cam. An axial center of the drive member approximately matches the axial center P. The drive member can rotate about the axial center P with respect to the cam. The drive member has the same structure as that of an outer race of a roller bearing. The plurality of rolling elements are arranged between an outer peripheral surface of the cam and an inner peripheral surface of the drive member. The rolling element is a needle roller, and extends along the axial center direction of the pump rotation shaft

The pump 3 includes the housing 8, the pump rotation shaft, the cam unit 3M, and the plurality of (five) pump parts 3A to 3E. Each of the pump parts 3A to 3E is a piston pump (reciprocating pump), and is configured to suck and discharge the brake fluid as working fluid as a result of a reciprocating motion of the piston (plunger) 36. The cam unit 3M has a function of converting the rotational motion of the pump rotation shaft to the reciprocating motions of the pistons 36. Hereinafter, when components of the respective pump parts 3A to 3E are distinguished from one another, suffixes A to E are added to reference symbols. The respective pistons 36 are arranged around the cam unit 3M, and are respectively accommodated in the cylinder accommodating holes 82. An axial center 360 of the piston 36 approximately matches the axial center of the cylinder accommodating hole 82, and extends in a radial direction of the pump rotation shaft. In other words, the number of pistons 36 is equal to the number (five) of the cylinder accommodating holes 82, and the pistons 36 extend in the radiation directions with respect to the axial center O. The pistons 36A to 36E are arranged approximately equiangularly in a circumferential direction of the pump rotation shaft (hereinafter simply referred to as “circumferential direction”), in other words, at approximately equal intervals in a rotation direction of the pump rotation shaft. The axial centers 3604 to 360E of those pistons 36A to 36E are on the same plane α. Those pistons 36A to 36E are driven by the same pump rotation shaft and the same cam unit 3M.

Each of the pump parts 3A to 3E includes a cylinder sleeve 30, a filter member 31, a plug member 32, a guide ring 33, a first seal ring 34, a second seal ring 35, the piston 36, a return spring 37, a suction valve 38, and a discharge valve 39, and those components are provided in the cylinder accommodating hole 82. The cylinder sleeve 30 has a bottomed tubular shape, and a hole 301 passes through a bottom part 300. The cylinder sleeve 30 is fixed in the cylinder accommodating hole 82. An axial center of the cylinder sleeve 30 approximately matches the axial center 360 of the cylinder accommodating hole 82. An end 302 on an opening side of the cylinder sleeve 30 is arranged in the medium-diameter part 822 (suction port 823), and the bottom part 300 is arranged in the large-diameter part (discharge port) 821. The filter member 31 has a bottomed tubular shape. A hole 311 passes through a bottom part 310, and a plurality of openings pass through a sidewall part. Filters are provided in the openings. An end 313 on an opening side of the filter member 31 is fixed to the end part 302 on the opening side of the cylinder sleeve 30. The bottom part 310 is arranged in the small-diameter part 820. An axial center of the filter member 31 approximately matches the axial center 360 of the cylinder accommodating hole 82. There is a gap between an outer peripheral surface on Which the openings of the filter member 31 open and an inner peripheral surface of the cylinder accommodating hole 82 (suction port 823). The passages on the suction side communicate with the suction port 823 and the gap. The plug member 32 has a cylindrical shape, and includes a recessed part 320 and a groove (not shown) on one end side in the axial center direction. This groove extends in the radial direction, connects the recessed part 320 and an outer peripheral surface of the plug member 32 to each other, and communicates with the discharge port 821. One end side in the axial direction of the plug member 32 is fixed to the bottom part 300 of the cylinder sleeve 30. An axial center of the plug member 32 approximately matches the axial center 360 of the cylinder accommodating hole 82. The plug member 32 is fixed to the large-diameter part 821, and closes the opening of the cylinder accommodating hole 82 on an outer peripheral surface of the housing 8. The passages on the discharge side communicate with the discharge port 821 and the groove of the plug member 32. The guide ring 33 has a tubular shape, and fixed to a side (small-diameter part 820) closer to the cam accommodating hole 81 than the filter member 31 in the cylinder accommodating hole 82. An axial center of the guide ring 33 approximately matches the axial center 360 of the cylinder accommodating hole 82. The first seal ring 34 is provided between the guide ring 33 and the filter member 31 in the cylinder accommodating hole 82 (small-diameter part 820).

The piston 36 has a cylindrical shape, has an end surface (hereinafter referred to as “piston end surface”) 361 on one side in an axial center direction, and a flange part 362 on an outer periphery on the other side in the axial center direction. The piston end surface 361 has a flat surface shape extending in a direction approximately orthogonal to the axial center 360 of the piston 36, and has an approximately circular shape with the axial center 360 as a center. The piston 36 has an axial hole 363 and a radial hole 364. The axial hole 363 extends on the axial center 360, and is opened in an end surface on the other side in the axial center direction of the piston 36. The radial hole 364 extends in the radial direction of the piston 36, is opened in the outer peripheral surface on the one side in the axial center direction with respect to the flange part 362, and is connected to the one side in the axial center direction of the axial hole 363. A check valve case 365 is fixed to an end on the other side in the axial center direction of the piston 36. The check valve case 365 is formed of a thin plate having a bottomed tubular shape, and includes a flange part 366 on an outer periphery of an end on an opening side, and a plurality of holes 368 pass through a sidewall part and a bottom part 367. The end on the opening side of the check valve case 365 is fitted to an end on the other side in the axial center direction of the piston 36. The second seal ring 35 is provided between the flange part 366 of the check valve case 365 and the flange part 362 of the piston 36. The other side in the axial center direction of the piston 36 is inserted onto an inner peripheral side of the cylinder sleeve 30, and the flange part 362 is thus guided and supported by the cylinder sleeve 30. The one side in the axial center direction of the piston 36 with respect to the radial hole 364 is inserted onto an inner peripheral side (hole 311) of the bottom part 310 of the filter member 31, an inner peripheral side of the first seal ring 34, and an inner peripheral side of the guide ring 33, and is guided and supported thereby. The axial center 360 of the piston 36 approximately matches the axial centers of the cylinder sleeve 30 and the like (cylinder accommodating hole 82). The end (piston end surface 361) on the one end side in the axial center direction of the piston 36 protrudes into the cam accommodating hole 81.

The return spring 37 is a compression spring, and is provided on the inner peripheral side of the cylinder sleeve 30. One end of the return spring 37 is provided in the bottom part 300 of the cylinder sleeve 30, and the other end is provided in the flange part 366 of the check valve case 365. The return spring 37 is configured to always bias the piston 36 to the side of the cam accommodating hole 81 side with respect to the cylinder sleeve 30 (cylinder accommodating hole 82). The suction valve 38 includes a ball 380 as a valve body and a return spring 381, and the ball 380 and the return spring 381 are accommodated on an inner peripheral side of the check valve case 365. A valve seat 369 is provided around an opening of the axial hole 363 on the end surface on the other side in the axial center direction of the piston 36. The axial hole 363 is closed by the ball 380 seating on the valve seat 369. The return spring 381 is a compression coil spring, one end thereof is provided in the bottom part 367 of the check valve case 365, and the other end is provided on the ball 380. The return spring 381 is configured to always bias the ball 380 toward the valve seat 369 side with respect to the check valve case 365 (piston 36). The discharge valve 39 includes a ball 390 as a valve body and a return spring 391, and the ball 390 and the return spring 391 are accommodated in a recessed part 320 of the plug member 32. A valve seat 303 is provided around an opening of the through hole 301 in the bottom part 300 of the cylinder sleeve 30. The through hole 301 is closed by the ball 390 seating on the valve seat 303. The return spring 391 is a compression coil spring, one end thereof is provided in a bottom surface of the recessed part 320, and the other end is provided on the ball 390. The return spring 391 is configured to always bias the ball 390 toward the valve seat 303 side.

A space R1 on the cam accommodating hole 81 side with respect to the flange part 362 of the piston 36 inside the cylinder accommodating hole 82 is a space on the suction side communicating with the suction oil passage 12 in the housing 8. Specifically, a space from the gap between the outer peripheral surface of the filter member 31 and the inner peripheral surface (suction port 823) of the cylinder accommodating hole 82 to the radial hole 364 and the axial hole 363 of the piston 36 via the plurality of openings 312 of the filter member 31 and a gap between an outer peripheral surface of the piston 36 and an inner peripheral surface of the filter member 31 functions as the suction-side space R1. Communication of this suction-side space R1 with the cam accommodating hole 81 is suppressed by the first seal ring 34. A space R3 between the cylinder sleeve 30 and the plug member 32 inside the cylinder accommodating hole 82 is a space on the discharge side communicating with the discharge oil passage 13 in the housing 8. Specifically, a space from the groove of the plug member 32 to the discharge port 821 functions as the discharge-side space R3. The volume of a space R2 between the flange part 362 of the piston 36 and the bottom part 300 of the cylinder sleeve 30 on the inner peripheral side of the cylinder sleeve 30 changes through a reciprocating motion (stroke) of the piston 36 with respect to the cylinder sleeve 30. This space R2 communicates with the suction-side space R1 through the opening of the suction valve 38 and the discharge-side space R3 through the opening of the discharge valve 39.

The piston 36 of each of the pump parts 3A to 3E reciprocates to provide a pump action. In other words, when the piston 36 performs a stroke toward the side approaching the cam accommodating hole 81 (axial center 510), the volume of the space R2 increases, and the pressure in R2 decreases. When the discharge valve 39 is closed, and the suction valve 38 is opened, the brake fluid as the working fluid flows from the suction-side space R1 into the space R2, and the brake fluid is supplied from the suction oil passage 12 to the space R2 via the suction port 823. When the piston 36 performs a stroke away from the cam accommodating hole 81, the volume of the space R2 decreases, and the pressure in R2 increases. When the suction valve 38 is closed, and the discharge valve 39 is opened, the brake fluid flows out from the space R2 to the discharge-side space R3, and the brake fluid is supplied to the discharge oil passage 13 via the discharge port 821. The brake fluid discharged by the respective pump parts 3A to 3E to the holes 88-31 to 88-38 is collected to the one hole 88-39 (discharge oil passage 13), and is used in common by the two systems of the hydraulic pressure circuit. The second unit 1B is configured to supply the brake fluid pressurized by the pump 3 to the brake operation units via the wheel cylinder pipes 10W, to thereby generate the brake hydraulic pressures (wheel cylinder pressures). The second unit 1B can supply the master cylinder pressure to the respective wheel cylinders W/C, and can use the hydraulic pressure generated by the pump 3 to individually control the hydraulic pressures of the respective wheel cylinders W/C independently of the brake operation by the driver in the state in which the communication between the master cylinder 5 and the wheel cylinders W/C is closed.

(ECU Fixation)

An ECU 90 is arranged on, and mounted to the rear surface 802 of the housing 8. In other words, the ECU 90 is integrally provided for the housing 8. The ECU 90 includes a control board 900 and a control unit housing (case) 901. The control board 900 is configured to control states of current supply to the motor 20 and the solenoids of the electromagnetic valves 21 and the like. Various sensors configured to detect a motion state of the vehicle, for example, an acceleration sensor configured to detect an acceleration of the vehicle and an angular velocity sensor configured to detect an angular velocity (yaw rate) of the vehicle may be mounted to the control board 900. Moreover, a complex sensor (combined sensor) which is a unit of those sensors may be mounted to the control board 900. The control board 900 is accommodated in the case 901. The case 901 is a cover member fixed through fastening with bolts b2 to the rear surface 802 (bolt holes 892) of the housing 8. The rear surface 802 functions as a case mounting surface (cover member mounting surface). The bolt holes 892 function as fixing holes (fixing parts) for fixing the ECU 90 to the housing 8.

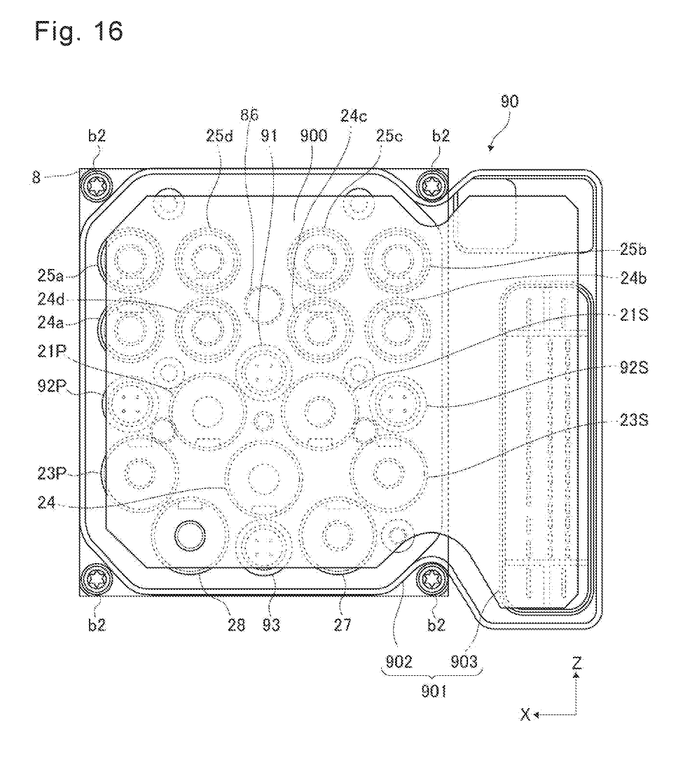

The case 901 is a cover member made of a resin material, and includes a board accommodating part 902 and a connector part 903. The board accommodating part 902 is configured to accommodate the control board 900 and some of the solenoids of the electromagnetic valves 21 and the like (hereinafter referred to as “control board 900 and the like”). The board accommodating part 902 includes a lid part 902a. The lid part 902a is configured to cover the control board 900 and the like for isolation from the outside. FIG. 16 is a diagram for illustrating the ECU 90 mounted to the housing 8 as viewed from the negative side in the Y-axis direction in the state in which the lid part 902a is removed. The control board 900 is mounted to the board accommodating part 902 approximately in parallel with the rear surface 802. Terminals of the solenoids of the electromagnetic valves 21 and the like, terminals of the hydraulic pressure sensor 91 and the like, and the conductive members (not shown) from the motor 20 protrude from the rear surface 802. The terminals and the conductive members extend to the negative side in the Y-axis direction, and are connected to the control board 900. The connector part 903 is arranged on the negative side in the X-axis direction with respect to the terminals and the conductive members in the board accommodating part 902, and protrudes toward a positive side in the Y-axis direction of the board accommodating part 902. The connector part 903 is arranged slightly on the outside (on the negative side in the X-axis direction) with respect to the left side surface 806 of the housing 8 as viewed in the Y-axis direction. Terminals of the connector part 903 are exposed toward the positive side in the Y-axis direction, and extend to the negative side in the Y-axis direction so as to be connected to the control board 900. Each of the terminals (exposed toward the positive side in the Y-axis direction) of the connector part 903 can be connected to external devices and the stroke sensor 94 (hereinafter referred to as “external devices and the like”). Electrical connections between the external devices and the like and the control board 900 (ECU 90) are achieved by another connector connected to the external devices and the like being inserted into the connector part 903 from the positive side in the Y-axis direction. Moreover, a current supply is carried out from an external power supply (battery) to the control board 900 via the connector part 903. The conductive members function as a connection part configured to electrically connect the control board and (the stator of) the motor 20 to each other, and a current is supplied to (the stator of) the motor 20 from the control board 900 via the conductive members.

The ECU 90 is configured to receive input of detection values of the stroke sensor 94, the hydraulic pressure sensor 91, and the like, and information on the travel state from the vehicle side, and control the opening/closing operations of the electromagnetic valves 21 and the like and the number of revolutions (namely a discharge amount of the pump 3) of the motor 20 based on a built-in program, to thereby control the wheel cylinder pressures (hydraulic pressure braking forces) of the respective wheels FL to RR. With such control, the ECU 90 carries out various types of brake control (for example, antilock brake control for suppressing slip of wheels caused by the braking, boost control for decreasing a brake operation force of the driver, brake control for motion control for the vehicle, automatic brake control, for example, preceding vehicle following control, and regeneration cooperative brake control). The motion control for the vehicle includes stabilization control of vehicle behavior such as lateral slipping. The regeneration cooperative brake control controls the wheel cylinder hydraulic pressures so as to achieve a target deceleration (target braking forces) in cooperation with regenerative braking.

The ECU 90 includes a brake operation amount detection part 90a, a target wheel cylinder hydraulic pressure calculation part 90b, a stepping force braking generation part 90c, a boost control part 90d, and a control switching part 90e. The brake operation amount detection part 90a is configured to receive input of the detection value of the stroke sensor 94, to thereby detect a displacement amount (pedal stroke) of the brake pedal 100 as a brake operation amount. The target wheel cylinder hydraulic pressure calculation part 90b is configured to calculate target wheel cylinder hydraulic pressures. Specifically, the target wheel cylinder hydraulic pressure calculation part 90b is configured to calculate, based on the detected pedal stroke, the target wheel cylinder hydraulic pressures for achieving a predetermined boost ratio, namely an ideal relationship between the pedal stroke and the brake hydraulic pressures of required by the driver (vehicle deceleration G required by the driver. Moreover, the target wheel cylinder hydraulic pressure calculation part 90b is configured to calculate the target wheel cylinder hydraulic pressures based on a relationship with a regenerative braking force during the regeneration cooperative brake control. For example, the target wheel cylinder hydraulic pressure calculation part 90b is configured to calculate such target wheel cylinder hydraulic pressures that a sum of a regenerative braking force input from a control unit of a regenerative braking device and a hydraulic pressure braking force corresponding to the target wheel cylinder hydraulic pressures satisfies the vehicle deceleration required by the driver. The target wheel cylinder hydraulic pressure calculation part 90b is configured to calculate the target wheel cylinder hydraulic pressures of the respective wheels FL to RR in order to achieve a desired vehicle motion state, for example, based on a detected vehicle motion state amount (for example, a lateral acceleration) during the motion control.

The stepping force braking generation part 90c is configured to set the pump 3 to a non-operation state, and control the shutoff valves 21 toward the open direction, control the SS/V IN 27 toward the closed direction, and control the SS/V OUT 28 toward the closed direction. In the state in which the shutoff valves 21 are controlled toward the open direction, the oil passage system (for example, the supply oil passages 11) connecting the hydraulic pressure chambers 50 of the master cylinder 5 and the wheel cylinders W/C to each other achieves stepping force braking (non-boost control) of generating the wheel cylinder hydraulic pressures through the master cylinder pressure generated by the pedal stepping force. The SS/V OUT 28 is controlled toward the closed direction, and the stroke simulator 6 does not thus function. In other words, the operation of the piston 61 of the stroke simulator 6 is suppressed, and the inflow of the brake fluid from the hydraulic pressure chamber 50 (secondary chamber 50S) to the positive pressure chamber 601 is thus suppressed. As a result, the wheel cylinder hydraulic pressures can more efficiently be boosted. The S/V IN 27 may be controlled toward the closed direction.

In the state in which the SS/V IN 27 is controlled toward the closed direction, and the SS/V OUT 28 is controlled toward the open direction while the shutoff valves 21 are controlled toward the closed direction, a braking system (the suction oil passage 12, the discharge oil passage 13, and the like) connecting the reservoir 120 and the wheel cylinders W/C to each other functions as a so-called brake-by-wire system configured to generate the wheel cylinder hydraulic pressures through the hydraulic pressure generated by the pump 3, to thereby achieve the boost control, the regeneration cooperative control, and the like. The boost control part 90d is configured to operate the pump 3, control the shutoff valves 21 toward the closed direction, and control the communication valves 23 toward the open direction during the brake operation by the driver, to thereby bring the state of the second unit 1B into a state in which the wheel cylinder hydraulic pressures can be generated by the pump 3. As a result, the boost control part 90d is configured to carry out the boost control of using the discharge pressure of the pump 3 as a hydraulic pressure source to generate the wheel cylinder hydraulic pressures higher than the master cylinder pressure, to thereby generate the hydraulic pressure braking force that is not sufficiently generated by the brake operation force of the driver. Specifically, the boost control part 90d is configured to control the pressure regulating valve 24 while operating the pump 3 at a predetermined number of revolutions to adjust the brake fluid amount supplied from the pump 3 to the wheel cylinders W/C, to thereby achieve the target Wheel cylinder hydraulic pressures. In other words, the braking system 1 is configured to operate the pump 3 of the second unit 1B in place of an engine negative pressure booster, to thereby provide a boost function of assisting the brake operation force. Moreover, the boost control part 90d is configured to control the SS/V IN 27 toward the closed direction, and control the SS/V OUT 28 toward the open direction. With such control, the boost control part 90d causes the stroke simulator 6 to function. The control switching part 90e is configured to control the operation of the master cylinder 5, to thereby switch between the stepping force braking and the boost control based on the calculated target wheel cylinder hydraulic pressures. Specifically, when the start of the brake operation is detected by the brake operation amount detection part 90a, the control switching part 90e causes the stepping force braking generation part 90c to generate the wheel cylinder hydraulic pressures if the calculated target wheel cylinder hydraulic pressures are equal to or less than predetermined values (for example, values corresponding to the maximum value of the vehicle deceleration G generated during normal braking. Which is not sudden braking). Meanwhile, if the target wheel cylinder hydraulic pressures calculated upon the brake stepping operation exceed the predetermined values, the control switching part 90e causes the boost control part 90d to generate the wheel cylinder hydraulic pressures.

Moreover, the ECU 90 includes a sudden brake operation state determination part 90f and a second stepping force braking generation part 90g. The sudden brake operation state determination part 90f is configured to detect a brake operation state based on input from the brake operation amount detection part 90a and the like, to thereby determine whether or not the brake operation state is a predetermined sudden brake operation state. For example, the sudden brake operation state determination part 90f is configured to determine whether or not a change amount of the pedal stroke per unit time exceeds a predetermined threshold amount. The control switching part 90e is configured to switch the control so that the wheel cylinder hydraulic pressures are generated by the second stepping force braking generation part 90 when the brake operation state is determined to be the sudden brake operation state. The second stepping force braking generation part 90g is configured to operate the pump 3, and to control the shutoff valves 21 toward the closed direction, control the SS/V IN 27 toward the open direction, and control the SS/V OUT 28 toward the closed direction. With such control, there is achieved second stepping force braking of using the brake fluid having flowed out from the back pressure chamber 602 of the stroke simulator 6 to generate the wheel cylinder hydraulic pressures until the pump 3 can generate sufficiently high wheel cylinder pressures. The shutoff valves 21 may be controlled toward the open direction. Moreover, the SS/V IN 27 may be controlled toward the closed direction, and, in this case, the brake fluid from the back pressure chamber 602 is supplied to the wheel cylinder W/C side via the check valve 270 (in the open state because the pressure on the wheel cylinder W/C side is still lower than that on the back pressure chamber 602 side). In this embodiment, the brake fluid can efficiently be supplied from the back pressure chamber 602 side to the wheel cylinder W/C side by controlling the SS/V IN 27 toward the open direction. Then, when the brake operation state is no longer determined to be the sudden brake operation state, and/or a predetermined condition indicating that a discharge performance of the pump 3 has become sufficient is satisfied, the control switching part 90e switches the control so as to cause the boost control part 90d to generate the wheel cylinder hydraulic pressures. In other words, the boost control part 90d controls the SS/V IN 27 toward the closed direction, and controls the SS/V OUT 28 toward the open direction. With such control, the boost control part 90d causes the stroke simulator 6 to function. The control may be switched to the regeneration cooperative brake control after the second stepping force braking.

A description is now given of the operation.

[Switching of Control]

The SS/V OUT 28, the SS/V IN 27, and the check valve 270 are configured to adjust the flow of the brake fluid, which has flowed out from the back pressure port 874 into the housing 8. Those valves permit or inhibit the flow of the brake fluid, which has flowed from the back pressure port 874 into the housing 8, to any of the low pressure parts (the reservoir 120 and the wheel cylinders W/C), to thereby permit or inhibit the flow of the brake fluid from the master cylinder 5 to the stroke simulator 6 (positive pressure chamber 601). With such actions, those valves adjust the operation of the stroke simulator 6. Moreover, the SS/V OUT 28, the SS/V 1N 27, and the check valve 270 function as a switching part configured to switch a supply destination (outflow destination) of the brake fluid, which has flowed from the back pressure port 874 into the housing 8 (back pressure oil passage 16), between the reservoir 120 and the wheel cylinders W/C. The control switching part 90e is configured to control the SS/V OUT 28 toward the closed direction so as to achieve the second stepping force braking until the pump 3 can come to be able to generate sufficiently high wheel cylinder pressures when the brake operation state is determined to be the sudden brake operation state. As a result, the brake fluid, which has flowed from the back pressure chamber 602 of the stroke simulator 6 into the back pressure oil passage 16 via the back pressure pipe 10X, flows toward the supply oil passages 11 via the SS/V IN 27 (first simulator oil passage 17) and the check valve 270 (bypass oil passage 170). In other words, the supply destination of the brake fluid flowing from the back pressure chamber 602 of the stroke simulator 6 is switched to the wheel cylinders W/C. Thus, boost responsiveness of the wheel cylinder hydraulic pressures can be secured. When the pressure on the wheel cylinder W/C side exceeds the pressure on the back pressure chamber 602 side, the check valve 270 is automatically closed, and a counter flow of the brake fluid from the wheel cylinder W/C side to the back pressure chamber 602 side is suppressed. The pump 3 is not limited to the piston pump, and may be, for example, a gear pump. According to this embodiment, the pump 3 is the piston pump, and thus the responsiveness is relatively high. Thus, a period until the pump 3 comes to be able to generate sufficient wheel cylinder pressures after start of the operation is relatively short, and a period in which the second stepping force braking is operating can thus be decreased. When the brake operation state is not determined to be the sudden brake operation state, and/or the predetermined condition indicating that the discharge performance of the pump 3 has become sufficient is satisfied, the control switching part 90e controls the SS/V OUT 28 toward the open direction in order to cause the stroke simulator 6 to function. As a result, the brake fluid, which has flowed from the back pressure chamber 602 of the stroke simulator 6 into the back pressure oil passage 16 via the back pressure pipe 10X, flows toward the reservoir 120 via the SS/V OUT 28 (second simulator oil passage 18). In other words, the supply destination of the brake fluid flowing from the back pressure chamber 602 is the reservoir 120. Thus, excellent pedal feeling can be secured. Even when such a failure that the SS/V OUT 28 is stuck in the closed state occurs during operation of the stroke simulator 6, the piston 61 can return to the initial position by the brake fluid being supplied from the reservoir 120 side to the back pressure chamber 602 via the check valve 280.

[Distribution of Respective Members to First and Second Units]

The braking system 1 includes the first unit 1A and the second unit 1B. Mountability of the braking system 1 to the vehicle can thus be improved. The stroke simulator 6 is arranged in the first unit 1A. Thus, compared with a case in which the stroke simulator 6 is separate from the master cylinder 5 or the second unit 1B, the lengths of pipes that connect the master cylinder 5 or the second unit 1B and the stroke simulator 6 to each other can be decreased, and the number of the pipes can be decreased. Thus, an increase in complexity of the braking system 1 can be suppressed, and an increase in cost caused by the increase in the number of pipes can be suppressed. The stroke simulator 6 may be arranged in the second unit 1B. In this embodiment, the stroke simulator 6 is arranged in the first unit 1A, and the master cylinder 5 and the stroke simulator 6 are integrated into the first unit 1A. Thus, an increase in size of the second unit 1B can be suppressed compared with the case in which the stroke simulator 6 is arranged in the second unit 1B. A housing of the master cylinder 5 and a housing of the stroke simulator 6 may be provided independently of each other, and may be arranged, for example, spatially closely but separately. In this embodiment, the housing 7 of the master cylinder 5 and the housing 7 of the stroke simulator 6 are integrally provided. Thus, a pipe that connects the master cylinder 5 and the stroke simulator 6 to each other can be omitted. Specifically, the positive pressure oil passage 74 that connects the secondary chamber 50S of the master cylinder 5 and the positive pressure chamber 601 of the stroke simulator 6 to each other is formed inside the housing 7. Thus, the pipe that connects the secondary chamber 50S and the positive pressure chamber 601 to each other can be omitted. The housing of the master cylinder 5 and the housing of the stroke simulator 6 may be provided independently of each other, and may integrally be fixed to each other. In this embodiment, the housing 7 of the master cylinder 5 and the housing 7 of the stroke simulator 6 are shared in common. Thus, the positive pressure oil passage 74 can easily be formed inside the housing 7. The pipe that connects the stroke simulator 6 and the second unit 1B to each other does not include a pipe that connects the positive pressure chamber 601 and the second unit 1B to each other, and includes only the back pressure pipe 10X that connects the back pressure chamber 602 and the second unit 1B to each other. Thus, the number of the pipes that connect the first unit 1A (stroke simulator 6) and the second unit 13 to each other can be decrease& Moreover, the back pressure pipe 10X extending from the back pressure chamber 602 is connected to the second unit 1B. Thus, a pipe or an oil passage that connects the back pressure chamber 602 (stroke simulator 6) and the reservoir tank 4 to each other is not necessary in the first unit 1A, and the size of the first unit 1A can be decreased.

The electromagnetic valves, the hydraulic pressure sensor 91, and the like are arranged in the second unit 1B. Thus, an ECU for driving the electromagnetic valves is not required in the first unit 1A, and wires harness) for the electromagnetic valve control and sensor signal transmission are not necessary between the first unit 1A and the ECU 90 (second unit 1B). Thus, an increase in complexity of the braking system 1 can be suppressed, and an increase in cost caused by an increase in the number of wires can be suppressed. Moreover, the ECU is not arranged in the first unit 1A, and thus the size of the first unit 1A can be decreased, and the degree of freedom in layout can be increased. For example, the SS/V IN 27 and the SS/V OUT 28 are arranged in the second unit 1B. Thus, the first unit 1A does not need an ECU configured to for switching the operation of the stroke simulator 6, and wires (harness) for controlling the SS/V IN 27 and the SS/V OUT 28 are not necessary between the first unit 1A and the ECU 90 (second unit 1B). The ECU 90 is arranged in the second unit 1B, and the ECU 90 and the housing 8 (that accommodates the electromagnetic valves and the like) are integrated with each other as the second unit 1B. Thus, wires (harness) that connect the electromagnetic valves, the hydraulic pressure sensor 91, and the like and the ECU 90 to each other can be omitted. Specifically, terminals of solenoids of the electromagnetic valves 21 and the like and terminals of the hydraulic pressure sensor 91 and the like are directly connected to the control board 900 (without via harnesses and connectors outside the housing 8). For example, the harness that connects the ECU 90 and the SS/V IN 27 and the SS/V OUT 28 to each other can be omitted. The motor 20 is arranged in the second unit 19, and the housing 8 (that accommodates the pump 3) and the motor 20 are integrated with each other as the second unit 1B. The second unit 1B functions as the pump device. Thus, wires (harness) that connect the motor 20 and the ECU 90 to each other can be omitted. Specifically, the conductive members for the current supply and the signal transmission to the motor 20 are accommodated in the power supply hole 86 of the housing 8, and are directly connected (without via harnesses and connectors outside the housing 8) to the control board 900. The conductive members function as connection members that connect the control board 900 and the motor 20 to each other.

[About First Unit 1A]

The reservoir tank 4 is arranged in the uppermost part in the vertical direction of the first unit 1A in a state in which the first unit 1A is mounted to the vehicle. Thus, supplement of the brake fluid to the reservoir tank 4 and inspection of the amount of brake fluid can easily be performed. The stroke simulator 6 overlaps with the master cylinder 5 as viewed in the vertical direction. A projection area of the first unit 1A in the vertical direction can thus be decreased, thereby being capable of improving the mountability of the first unit 1A to the vehicle. An axial center direction of the piston 51 of the master cylinder 5 is approximately orthogonal to the vertical direction. An axial center direction of the piston 61 of the stroke simulator 6 approximately matches the axial center direction of the piston 51. Thus, an area in which the stroke simulator 6 and the master cylinder 5 overlap with each other as viewed in the vertical direction can be increased, and the projection area in the vertical direction of the first unit 1A can be decreased. The reservoir tank 4 overlaps with the master cylinder 5 and the stroke simulator 6 as viewed in the vertical direction. Thus, the projection area of the first unit 1A in the vertical direction can be decreased. In this embodiment, most of the master cylinder 5 and the stroke simulator 6 are covered by the reservoir tank 4 as viewed in the vertical direction. It is preferred that portions constructing the ports 76 and 77 for the pipe connection be not covered by the tank 4, and be thus exposed as viewed in the vertical direction. In this case, connection workability of the pipes 10M and 10X to the ports 76 and 77 can be improved. The reservoir tank 4, the master cylinder 5, and the stroke simulator 6 are within the width of the flange part 78 in the Y-axis direction. Thus, a size of the first unit 1A can be decreased in the lateral direction of the vehicle orthogonal to the pushrod 101. Therefore, the mountability of the first unit 1A to the vehicle can be improved.

[About Second Unit 1B]

(Pump Pulse Pressure Reduction)

The pump 3 may include a piston that is reciprocated by the motion of the cam, and a specific configuration is not limited to that of this embodiment. For example, the number of the pump parts (pistons 36) may be one or two, and is not limited to five. In this embodiment, the plurality of pump parts are provided. Thus, a phase of suction/discharge strokes of the respective pump parts 3A to 3E can be displaced from one another. As a result, periodical variations (pulse pressures) of discharge pressure of the respective pump parts 3A to 3E can be canceled one another, and the pulse pressure in the entire pump 3 can be reduced. In other words, the pulsation of the flow in the hole 88-39 (discharge oil passage 13) into which the respective pump parts 3A to 3E discharge in common the brake fluid can be suppressed to be low, thereby being capable of decreasing noise and vibration of the braking system 1. The pulse pressure of the entire pump 3 corresponds to variation in load torque in accordance with the rotation angle of the pump rotation shaft. The pulse pressure reduction effect corresponding to the number of pump parts 3 can be verified by observing the variation in load torque.

The respective pistons 36 are arranged at approximately equal intervals in the circumferential direction. In other words, the respective pistons 36 are arranged approximately equiangularly in the circumferential direction. Thus, phase displacements of the suction/discharge strokes can be approximately even between the pump parts 3A to 3E, thereby being capable of attaining a significant pulse pressure reduction effect. The number of the pump parts 3 may be an even number. In this embodiment, the number described above is an odd number equal to or more than three. Thus, the amplitude of the pulse pressure (range of variation) can easily be decreased compared with the cases in which the number of the pump parts is an even number, and the significant pulse pressure reduction effect can be attained. For example, when the number of the pump parts is three, there can be attained the pulse pressure reduction effect greater than that of the case in which the number is six. In this embodiment, the number describe above is five. Thus, the pulse pressure reduction effect can be improved, thereby being capable of attaining sufficient silence, and securing a sufficient flow rate of the pump 3 compared with the case in which the number is three. Moreover, compared with the case in which the number is six or more, the increase in the number of the pump parts 3 can be suppressed, which is advantageous in terms of the layout and the like, and the size of the second unit 1B can easily be decreased. The brake fluid in the hole 88-39 flows to the hole 88-310 via the dumper chamber 831. The damper chamber 831 is a volume chamber in the oil passages. The damper chamber 831 functions as the damper 130, and is configured to absorb pulsation of the brake fluid in the discharge oil passage 13 discharged from the pump 3. As a result, the pulse pressure is further reduced.

(Improvement in Workability)

The master cylinder ports 871 and the wheel cylinder ports 872 are arranged on the upper side in the vertical direction of the housing 8. Thus, workability of respectively mounting the pipes 10MP, 10MS, and 10W to the ports 871 and 872 of the housing 8 provided on the vehicle body side can be improved. The wheel cylinder ports 872 are opened in the top surface 803. Therefore, the workability can further be improved. The master cylinder ports 871 are opened at the end on the upper side in the vertical direction of the front surface 801. Therefore, the workability can further be improved.

(Reservoir Function)

The reservoir chamber 830 is configured to receive the brake fluid supplemented from the reservoir tank 4 via the pipe 10R, and supply the brake fluid to the suction ports 823 of the respective pump parts 3A to 3E. The respective pump parts 3A to 3E are configured to suck and discharge the brake fluid via the reservoir 120. The reservoir chamber 830 is a volume chamber in the oil passages. When the suction pipe 10R is detached from the nipple 10R1 or 10R2, or when a band for tightening the suction pipe 10R to the nipple 10R1 or 10R2 is loosened, and the brake fluid thus leaks from the suction pipe 10R, the reservoir chamber 830 functions as the reservoir 120 that is configured to reserve the brake fluid. The pump 3 can suck and discharge the brake fluid in the reservoir 120, to thereby generate the wheel cylinder pressures, and can generate the braking torque in the vehicle in which the braking system 1 is mounted. The suction port 873 is formed on the upper side in the vertical direction with respect to the intake ports 823 of the pump parts 3A to 3E. Thus, even when leakage of a fluid from the suction pipe 10R occurs, the brake fluid can be reserved in at least some of oil passages extending from the suction port 873 to the suction ports 823 of the pump 3, and the pump 3 can use this brake fluid to generate the discharge pressure. In other words, at least sonic of the oil passages in which the brake fluid is reserved can be caused to function as the reservoir 120. It is not always required that the suction port 873 be opened in the top surface 803. The suction port 873 in this embodiment is opened in the top surface 803. In other words, the suction port 873 is formed toward the top side in the vertical direction, and is opened in the top side in the vertical direction. Thus, the brake fluid can be reserved in entire oil passages extending from the suction port 873 to the suction ports 823 of the pump 3. It is preferred that the suction port 873 be positioned on a lower side in the vertical direction with respect to the supply port 41 of the reservoir tank 4. In this case, the brake fluid can always be supplemented from the reservoir tank 4 to the suction port 873 via the pipe 10R.

It is preferred that the reservoir chamber 830 has a capacity (volume) enabling the vehicle in which the braking system 1 is mounted to use the pump 3 to generate a predetermined braking torque (for example, −0.25 G). In this case, even when the liquid leak from the suction pipe 10R occurs, the brake control by the pump 3 can be continued by using the brake fluid in the reservoir 120. The reservoir chamber 830 is arranged on the upper side in the vertical direction with respect to the intake ports 823 of the pump parts 3A to 3E. Thus, the brake fluid can easily be supplied from the reservoir chamber 830 to the suction ports 823 of the pump 3. The suction port 873 may be connected to the reservoir chamber 830 via an oil passage. In this embodiment, the suction port 873 is directly connected to the reservoir chamber 830. In other words, the reservoir chamber 830 is opened in the top surface 803, and this opening functions as the suction port 873. The reservoir chamber 830 includes the suction port 873, and is opened in the suction port 873. Thus, the one end of the reservoir chamber 830 can be arranged as close to the top surface 803 side as possible, and a large substantial capacity of the reservoir 120 can be secured. Moreover, the reservoir chamber 830 is opened in the upper side in the vertical direction. Thus, even when the liquid leak from the suction pipe 10R occurs, leakage of the brake fluid from the reservoir chamber 830 is suppressed. Thus, the reservoir chamber 830 can be caused to function as the reservoir 120.

(Drain Function)

The brake fluid leaks from each of the cylinder accommodating holes 82 to the cam accommodating hole 81 via the first seal ring 34. For example, the brake fluid leaks from the suction-side space R1 via a gap between the piston 36 and the first seal ring 34. The brake fluid that has leaked into the cam accommodating hole 81 flows into the liquid reservoir chamber 832 via the oil passage hole 881, and is reserved in the liquid reservoir chamber 832. Thus, entry of the brake fluid in the cam accommodating hole 81 into the motor 20 is suppressed, and an operation performance of the motor 20 can be improved. The liquid reservoir chamber 832 is arranged on the negative side in the Z-axis direction with respect to the cam accommodating hole 81. Thus, the brake fluid that has leaked from each of the cylinder accommodating holes 82 into the cam accommodating hole 81 can flow by its own weight from the cam accommodating hole 81 to the liquid reservoir chamber 832. As a result, the leaked brake fluid can efficiently be reserved in the liquid reservoir chamber 832. The liquid reservoir chamber 832 is opened in the bottom surface 804. Thus, the one end of the liquid reservoir chamber 832 can be arranged as close to the bottom surface 804 side as possible, and a large substantial capacity of the liquid reservoir chamber 832 can be secured. The opening of the liquid reservoir chamber 832 is closed by a lid member. Moreover, an amount of the brake fluid exceeding the capacity of the liquid reservoir chamber 832 can be returned to the suction ports 823 of the pump 3 via the hole 88-46.

(Suppression of Air Stagnation)

When the housing 8 is viewed along the vertical direction, the holes which are subject to high pressure are mainly formed on the lower side in the vertical direction with respect to the axial center O, and the holes which are subject to low pressure are mainly formed on the upper side in the vertical direction. Thus, stagnation of the air in the oil passages connecting those holes can be suppressed. For example, the damper chamber 831 is arranged on the lower side in the vertical direction with respect to the cam accommodating hole 81. Thus, the brake fluid at high pressure discharged from e discharge ports 821 of the pump 3 into the damper chamber 831 can be caused to flow from the lower side in the vertical direction of the housing 8 to the upper side in the vertical direction. The damper chamber 831 is opened in the bottom surface 804. Thus, the damper chamber 831 can be arranged as close to the bottom side in the vertical direction as possible, and a dead space on the lower side in the vertical direction with respect to the damper chamber 831 can be decreased in the housing 8. In other words, the holes which are subject to relatively high pressure and are on an upstream side of the flow of the brake fluid are arranged on the lower side in the vertical direction of the housing 8, and the holes which are subject to relatively low pressure and are on a downstream side of the flow of the brake fluid are arranged on the upper side in the vertical direction of the housing 8. As a result, the flow of the brake fluid tends to be directed from the lower side in the vertical direction of the housing 8 to the upper side in the vertical direction. Thus, stagnation of air (air bubbles) in the oil passages can be suppressed. For example, the communication valve accommodating holes 843 and the pressure regulating valve accommodating hole 844 immediately communicating with the damper chamber 831 are subject to high pressure, and are thus arranged on the lower side in the vertical direction of the housing 8. The SOL/V IN accommodating holes 842 and the SOL/V OUT accommodating holes 845 are on a downstream side of the communication valve accommodating holes 843 and the pressure regulating valve accommodating hole 844, and are thus arranged on the upper side in the vertical direction of the housing 8. When the SS/V IN 27 is opened, the SS/V IN accommodating hole 847 is on an upstream side with respect to the shutoff valve accommodating holes 841, and the SS/V IN accommodating hole 847 is thus arranged on the lower side in the vertical direction with respect to the shutoff valve accommodating hole 841, specifically, on the lower side in the vertical direction with respect to the axial center O.

(Decrease in Size and Improvement in Ease of Layout)

The housing 8 is arranged between the motor 20 and the ECU 90. Specifically, the motor 20, the housing 8, and the ECU 90 are arrayed in this order along the axial center direction of the motor 20. Thus, the motor 20 and the ECU 90 can be arranged so as to overlap with each other as viewed from the motor 20 side (in the axial center direction of the motor 20) or the side of the ECU 90. As a result, the area of the second unit 1B as viewed from the motor 20 side or the ECU 90 side can be decreased, and the size of the second unit 1B can thus be decreased. The weight of the second unit 1B can be decreased by decreasing the size of the second unit 1B.

The connector part 903 of the ECU 90 is adjacent to (the left side surface 806 of) the housing 8 as viewed from the side motor 20 side (in the axial center direction of the motor 20). In other words, the connector part 903 is not covered by the housing 8, and protrudes from the side surface 806 of the housing 8 as viewed from the motor 20 side. Thus, an increase in dimension of the second unit 1B in the direction (Y-axis direction) along the axial center of the motor 2C) can be suppressed. The terminals of the connector part 903 are exposed toward the motor 20 side (positive side in the Y-axis direction). Thus, a connector (harness) connected to the connector part 903 overlaps with the housing 8 and the like in the axial center direction (Y-axis direction) of the motor 20, and an increase in dimension in the Y-axis direction (axial center direction of the motor 20) of the second unit 1B including the connector (harness) can be suppressed. The connector part 903 is adjacent to the left side surface 806 of the housing 8. Thus, compared with a case in which the connector part 903 is adjacent to the top surface 803 of the housing 8, interference between the connector (harness) connected to the connector part 903 and the pipes 10MP and 10MS connected to the master cylinder ports 871 can be suppressed. Moreover, interference between the vehicle-body-side member (mount 102) to which the bottom surface 804 is opposed, and the connector (harness) can be suppressed compared with a case in which the connector part 903 is adjacent to the bottom surface 804 of the housing 8. The connector part 903 may be adjacent to the right side surface 805 of the housing 8. In this embodiment, the connector part 903 is adjacent to the left side surface 806 of the housing 8. Ports, for example, the back pressure port 874, are not formed on the left side surface 806. Thus, compared with a case in which the connector part 903 is adjacent to the right side surface 805 of the housing 8, interference between the connector (harness) connected to the connector part 903 and the pipe 10X connected to the back pressure port 874 can be suppressed. In other words, when the connector (harness) is connected to the connector part 903, the connection can easily be carried out. Thus, mounting workability of the braking system 1 in the vehicle can be increased.

The housing 8 includes the plurality of cylinder accommodating holes 82 configured to accommodate the pistons 36 of the pump 3 and the plurality of the valve body accommodating holes 84 configured to accommodate the valve bodies of the electromagnetic valves 21 and the like. Those cylinder accommodating holes 82 and the valve body accommodating holes 84 at least partially overlap with each other as viewed from the motor 20 side (in the axial center direction of the motor 20). Thus, the area of the second unit 1B as viewed from the motor 20 side (in the axial center direction of the motor 20) can be decreased.

The plurality of the cylinder accommodating holes 82 are provided in the radiation form about the axial center O of the motor 20. Thus, there can be provided a region in which the respective cylinder accommodating holes 82A to 82E overlap with one another in the axial center direction of the motor 20. As a result, an increase in dimension of the housing 8 in the axial center direction of the motor 20 can be suppressed. As viewed from the motor 20 side (in the axial center direction of the motor 20), most of the plurality of the valve body accommodating holes 84 are contained in the circle connecting the ends of the cylinder accommodating holes 82 on the large-diameter part 821 side (side farther from the axial center O) to each other. In addition, the outer periphery of this circle and the valve body accommodating holes 84 can also at least partially overlap with each other. Thus, the area of the second unit 1B as viewed from the motor 20 side (in the axial center direction of the motor 20) can be decreased. The number of the plurality of cylinder accommodating holes 82 is five. Thus, a distance between the cylinder accommodating holes 82 which are adjacent to each other is short in the circumferential direction about the axial center O. However, the cylinder accommodating holes 82 and the valve body accommodating holes 84 at least partially overlap with each other as viewed from the motor 20 side (in the axial center direction of the motor 20), and most of the plurality of the valve body accommodating holes 84 can thus be contained in the above-mentioned circle.

The two cylinder accommodating holes 82A and 82E on the positive side in the Z-axis direction are arranged on both the sides in the X-axis direction with respect to the axial center O. Thus, the cylinder accommodating hole 82 is not opened at the center in the X-axis direction close to the axial center O on the top surface 803, and a large space can be secured for opening the other hole (reservoir chamber 830).

The cylinder accommodating holes 82A to 82E are arrayed in the single row along the axial center direction of the motor 20. Specifically, the axial centers 360 of the cylinder accommodating holes 82A to 82E are approximately on the same plane α that is approximately orthogonal to the axial center O. Thus, the cam unit 3M can be used in common for the plurality of pistons 36, an increase in the number of the cam units 3M can thus be suppressed, and an increase in the number of the components and cost can be suppressed. Moreover, the pump rotation shaft can be shortened by suppressing the increase in the number of the cam units 351, and an increase in dimension of the housing 8 in the axial center direction of the motor 20 can thus be suppressed. As a result, the size and the weight of the second unit 1B can be decreased. Moreover, the increase in dimension of the housing 8 in the axial center direction of the motor 20 can effectively be suppressed by maximizing a region of the overlap between the respective cylinder accommodating holes 82A to 82E in the Y-axis direction. The cylinder accommodating holes 82 are arranged on the front surface 801 side (on the side on which the motor 20 is mounted) of the housing 8. Thus, the rotation shaft of the pump 3 can be further shortened.

The recessed parts 807 and 808 are formed at the corners on the front surface 801 side and the top surface 803 side of the housing 8. Thus, the volume and the weight of the housing 8 can be decreased. The cylinder accommodating holes 82A and 82E are opened in the recessed parts 807 and 808. Thus, an increase in dimension in the axial center direction of the cylinder accommodating holes 82A and 82E can be suppressed, thereby being capable of improving ease of assembly of the pump components to those holes 82A and 82E.

The plurality of valve body accommodating holes 84 are arrayed in the single row along the axial center direction of the motor 20. As a result, the increase in dimension of the housing 8 in the axial center direction of the motor 20 can be suppressed. The valve body accommodating holes 84 are arranged on the rear surface 802 side (side on which the ECU 90 is mounted) of the housing 8. Thus, electrical connectivity between the ECU 90 and solenoids of the electromagnetic valves 21 and the like can be improved. Specifically, the axial centers of the plurality of valve body accommodating holes 84 are approximately in parallel with the axial center of the motor 20, and all of the valve body accommodating holes 84 are opened in the rear surface 802. Thus, the solenoids of the electromagnetic valves 21 and the like can be arranged in a concentrated manner on the rear surface 802 of the housing 8, thereby being capable of simplifying electrical connections between the ECU 90 and the solenoids. Similarly, the plurality of sensor accommodating holes 85 are arranged on the rear surface 802 side. Thus, the electrical connectivity between the ECU 90 and the hydraulic pressure sensors 91 and the like can be improved. The control board 900 of the ECU 90 is arranged approximately in parallel with the rear surface 802. Thus, the electrical connection between the ECU 90 and the solenoids (and the sensors) can be simplified.

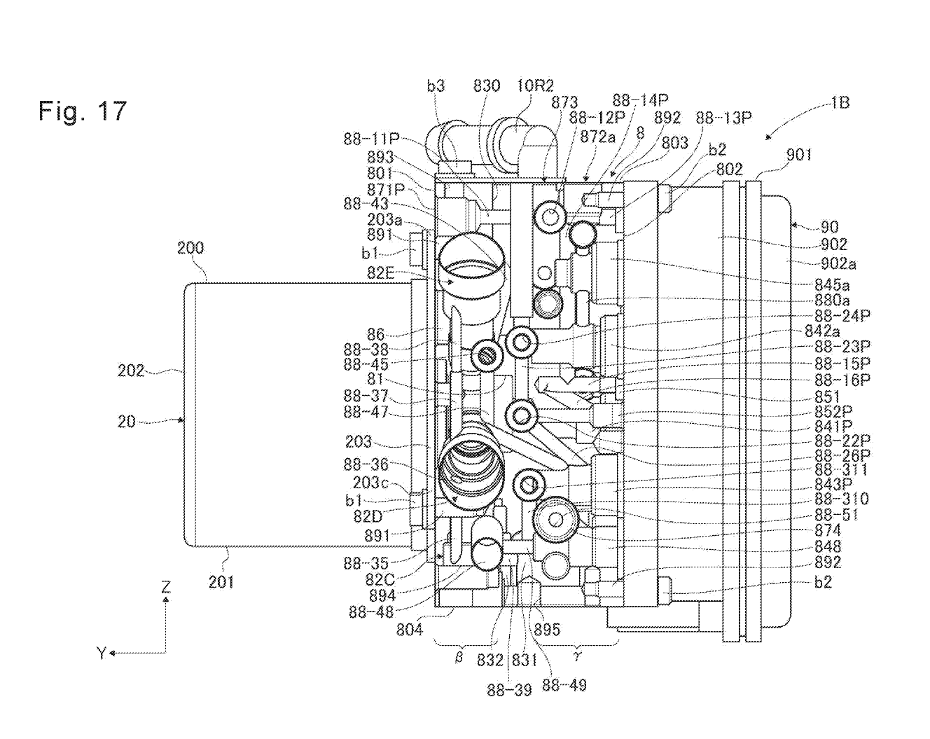

FIG. 17 is a right side view for illustrating the second unit 1B as viewed from the positive side in the X-axis direction, and is an illustration of the passages and the like with transparency in the housing 8. Illustration of components, for example, the pump 3 and the electromagnetic valves 21 is omitted. The housing 8 includes a pump region (pump part) β and an electromagnetic valve region (electromagnetic valve part) y arranged in this order from the front surface 801 side toward the rear surface 802 side along the axial center direction of the motor 20. A region in which the cylinder accommodating holes 82 are located is the pump region β, and a region in which the valve body accommodating holes 84 are located is the electromagnetic valve region γ, along the axial center direction of the motor 20. The increase in dimension of the housing 8 in the axial center direction of the motor 20 is easily suppressed by arranging the cylinder accommodating holes 82 and the valve body accommodating holes 84 in the respective regions in the axial center direction of the motor 20 in a concentrated manner. Moreover, ease of layout of the respective elements in the housing 8 can be increased, and the size of the housing 8 can be decreased. In other words, the degree of freedom in layout of the plurality of holes on a plane orthogonal to the axial center of the motor 20 is improved in each of the regions β and γ. For example, the plurality of valve body accommodating holes 84 can easily be arranged so as to suppress an increase in dimension of the housing 8 on the plane in the electromagnetic valve region γ. Both the regions β and γ may partially overlap with each other in the axial center direction of the motor 20.

Approximately the same numbers of the plurality of valve body accommodating holes 84 are respectively formed on the both sides in the Z-axis direction with respect to the axial center O. Specifically, the number of the valve accommodating holes 84 is 15, slightly more than eight thereof are formed on the positive side in the Z-axis direction with respect to the axial center O, and a slightly less than seven thereof are formed on the negative side in the Z-axis direction. Therefore, concentration of the valve body accommodating holes 84 on one side of the axial center O in the Z-axis direction and a consequent unbalanced increase in dimension of the housing 8 can be suppressed. Approximately the same numbers of the plurality of valve body accommodating holes 84 are respectively formed on the both sides in the X-axis direction with respect to the axial center O. Thus, concentration of the valve body accommodating holes 84 on one side of the axial center O in the X-axis direction and a consequent unbalanced increase in dimension of the housing 8 can be suppressed. Specifically, the holes 84 and 85 in the P system are mainly arranged on the positive side in the X-axis direction with respect to the axial center O, and the holes 84 and 85 in the S system are mainly arranged on the negative side in the X-axis direction. Thus, approximately the same numbers of the holes 84 and 85 can easily be formed on both sides in the X-axis direction with respect to the axial center O.

The plurality of valve body accommodating holes 84 are arranged in two rows in the Z-axis direction on the positive side in the Z-axis direction with respect to the axial center O, and in three rows in the Z-axis direction on the negative side in the Z-axis direction with respect to the axial center O. The three rows on the negative side in the Z-axis direction partially overlap with each other in the Z-axis direction. Thus, even on the negative side in the Z-axis direction, the dimension in the Z-axis direction substantially corresponds to approximately two rows. Thus, the dimensions in the Z-axis direction of the housing 8 can approximately be the same on the both sides in the Z-axis direction with respect to the axial center O. Specifically, in the P system, the opening of the pressure regulating valve accommodating hole 844 and the opening of the communication valve accommodating hole 843P, and the opening of the shutoff valve accommodating hole 841P and the opening of the SS/V IN accommodating hole 847 partially overlap with each other in the Z-axis direction (as viewed in the X-axis direction). The same holds true for the S system. Thus, an increase in dimension in the Z-axis direction of the rear surface 802 can be suppressed.

The plurality of valve body accommodating holes 84 are in four rows in the X-axis direction on the positive side in the Z-axis direction with respect to the axial center O. Thus, the electromagnetic valves (SS/V IN 22 and the like) can easily be arranged so as to correspond to the four wheels FL to RR. The plurality of valve body accommodating holes 84 are formed in five rows in the X-axis direction on the negative side in the Z-axis direction with respect to the axial center O, and partially overlap with one another in the X-axis direction. Thus, even on the negative side in the Z-axis direction, the dimension in the Z-axis direction substantially corresponds to approximately four rows. Thus, the dimensions in the X-axis direction can approximately be the same on the both sides in the Z-axis direction with respect to the axial center of the motor 20. Specifically, in the P system, the opening of the pressure regulating valve accommodating hole 844 and the opening of the shutoff valve accommodating hole 841P partially overlap with each other in the X-axis direction (as viewed in the Z-axis direction), and the opening of the communication valve accommodating hole 843P and the opening of the SS/V IN accommodating hole 847 partially overlap with each other in the X-axis direction (as viewed in the Z-axis direction). The same holds true for the S system. Thus, an increase in dimension in the X-axis direction of the rear surface 802 can be suppressed.

On the negative side in the Z-axis direction with respect to the axial center O, the plurality of valve body accommodating holes 84 are formed in a staggered pattern (so as to alternate), and the openings of the valve accommodating holes 84 partially overlap with one another in the X-axis direction and the Z-axis direction on the rear surface 802. Thus, as described above, the pressure regulating valve accommodating hole 844 can be formed at an intermediate position between the groups of the valve body accommodating holes 84 in both the P and S systems while the increases in dimension in the Z-axis direction and the X-axis direction are suppressed on the rear surface 802. As a result, when the one pressure regulating valve is used both in the P and S systems, the pressure regulating valve accommodating hole 844 can easily be connected to the oil passages in both the systems, thereby simplifying the oil passage configuration. Moreover, the space can effectively be used by forming the sensor accommodating holes 85 between the plurality of valve body accommodating holes 84.

The plurality of valve body accommodating holes 84 are formed so that valves having the same function or valves functionally close to one another in the distance in the hydraulic pressure circuit are arranged in the rows as viewed in the X-axis direction. Thus, the layout of the oil passages in the housing 8 can be simplified, thereby being capable of suppressing an increase in size of the housing 8. The respective SOL/V INs 22 have the same function, and are thus arranged in a row in the X-axis direction. The respective SOL/V OUTs 25 have the same function, and are thus arranged in a row in the X-axis direction. The communication valves 23 and the pressure regulating valve 24 are functionally close to each other in the distance in the hydraulic pressure circuit, and are thus arranged in a row in the X-axis direction. The SS/V IN 27 and the SS/V OUT 28 are functionally close to each other in the distance in the hydraulic pressure circuit, and are thus arranged in a row in the X-axis direction.

The wheel cylinder ports 872 are opened in the top surface 803. Thus, the space on the front surface 801 can be saved compared with a case in which the wheel cylinder ports 872 are opened in the front surface 801, and the recessed parts 807 and 808 can easily be formed at the corners of the housing 8. The wheel cylinder ports 872 are formed on the negative side in the Y-axis direction on the top surface 803. Thus, the connection between the wheel cylinder ports 872 and the SOL/V IN accommodating holes 842 and the like is simplified by forming the wheel cylinder ports 872 in the electromagnetic valve region γ, while the interference between the wheel cylinder ports 872 and the cylinder accommodating ports 82 is avoided, thereby being capable of simplifying the oil passages. The four wheel cylinder ports 872 are arranged in a row in the X-axis direction on the negative side in the Y-axis direction on the top surface 803. Thus, an increase in dimension in the Y-axis direction of the housing 8 can be suppressed by forming the wheel cylinder ports 872 in the single row in the Y-axis direction.

The master cylinder ports 871 are opened in the front surface 801. Thus, the space on the top surface 803 can be saved compared with a case in which the master cylinder ports 871 are opened in the top surface 803, and the wheel cylinder ports 872 and the like can easily be formed at the top surface 803. The master cylinder ports 871P and 871S are on both sides of the reservoir chamber 830 in the X-axis direction (as viewed in the Y-axis direction). The reservoir chamber 830 is arranged between the ports 871P and 871S in the X-axis direction. The area of the front surface 801 can be decreased by using a space between the ports 871P and 871S to form the reservoir chamber 830 in this way, thereby decreasing the size of the housing 8. The ports 871P and 871S are formed respectively between the reservoir chamber 830 and the cylinder accommodating holes 82A and 82E in the circumferential direction of the axial center C) (as viewed in the Y-axis direction). Thus, an increase in dimension from the axial center C) to the outer surface (top surface 803) of the housing 8 can be suppressed, thereby being capable of decreasing the size of the housing 8. Moreover, the openings of the ports 871 on the front surface 801 can be formed on the center side in the X-axis direction, thereby being capable of forming the recessed parts 807 and 808 on the outer sides in the X-axis direction with respect to the ports 871P and 871S. The ports 871P and 871S open in a portion other than the motor housing 200 (flange part 203) on the front surface 801. The ports 871P and 871S are on both sides with respect to the bolt hole 891 as viewed in the Y-axis direction. The openings of the ports 871P and 871S and the opening of the bolt hole 891 partially overlap with each other in the Z-axis direction (as viewed in the X-axis direction). Thus, an increase in dimension in the Z-axis direction of the front surface 801 can be suppressed. In other words, an area (on the positive side in the Z-axis direction with respect to the motor housing 200) of a portion in which the ports 871P and 871S are formed can be decreased on the front surface 801, thereby being capable of decreasing the size of the housing 8.

The suction port 873 is opened on the center side in the Y-axis direction in the top surface 803. Thus, the suction port 873 can be formed between the electromagnetic valve region γ and the pump region β. Therefore, the suction port 873 (reservoir chamber 830) can easily be connected to both the valve body accommodating holes 84 and the cylinder accommodating holes 82 (suction ports 823 of the pump 3), thereby being capable of simplifying the oil passages. The suction port 873 is opened on the center side in the X-axis direction in the top surface 803. Thus, when the one reservoir 120 is used in common for both the P and S systems, the suction port 873 (reservoir chamber 830) can easily be connected to the valve body accommodating holes 84P and 845 in both the systems, thereby being capable of simplifying the oil passages.

The wheel cylinder ports 872c and 872d are on both sides with respect to the suction port 873 (reservoir chamber 830), and the openings of the ports 872c and 872d and the suction port 873 (reservoir chamber 830) partially overlap with each other in the X-axis direction (as viewed in the Y-axis direction). Thus, an increase in dimension in the X-axis direction of the housing 8 can be suppressed, thereby being capable of decreasing the size. The openings of the ports 872c and 872d and the suction port 873 partially overlap with each other in the Y-axis direction (as viewed in the X-axis direction). Thus, an increase in dimension in the Y-axis direction of the top surface 803 can be suppressed. In other words, the area of a portion (on the positive side in the Y-axis direction with respect to the ports 872c and 872d or on the positive side in the Y-axis direction with respect to the electromagnetic valve region γ) in which the suction port 873 is formed can be decreased on the top surface 803, thereby being capable of decreasing the size of the housing 8. The cylinder accommodating holes 82A and 82E are on both the sides of the suction port 873 in the X-axis direction (as viewed in the Y-axis direction), and the openings of the holes 82A and 82E and the suction port 873 partially overlap with each other in the Y-axis direction (as viewed in the X-axis direction). Thus, the increase in dimension in the Y-axis direction of the top surface 803 can be suppressed. In other words, the area of a portion (on the negative side in the Y-axis direction with respect to the ports 82A and 82E or on the negative side in the Y-axis direction with respect to the pump region β) in which the suction port 873 is formed can be decreased on the top surface 803, thereby being capable of decreasing the size of the housing 8.

The reservoir chamber 830 is formed in the region between the cylinder accommodating holes 82A and 82E which are adjacent to each other in the circumferential direction of the axial center O. Thus, the increase in dimension from the axial center O to the outer surface (top surface 803) of the housing 8 extending along the circumferential direction of the axial center O can be suppressed, thereby being capable of decreasing the size of the housing 8. Moreover, the oil passages connecting the reservoir chamber 830 and the suction ports 823 of the pump 3 to each other can be shortened. The cylinder accommodating holes 82A and 82E and the reservoir chamber 830 partially overlap with each other in the Y-axis direction (as viewed in the X-axis direction). Thus, the increase in dimension in the Y-axis direction of the housing 8 can be suppressed, thereby being capable of decreasing the size. The reservoir chamber 830 is arranged in the region surrounded by the master cylinder ports 871P and 871S and the wheel cylinder ports 872c and 872d. The size of the housing 8 can be decreased by using the space between the respective ports to form the reservoir chamber 830 in this way.

The back pressure port 874 is opened in the right side surface 805. Thus, a space on the front surface 801 or the top surface 803 can be saved compared with a case in which the back pressure port 874 is opened in the front surface 801 or the top surface 803. Therefore, an increase in the area of the front surface 801 or the top surface 803 can be suppressed, thereby suppressing the increase in size of the housing 8. The back pressure port 874 is formed on the negative side in the Z-axis direction of the right side surface 805. Thus, the back pressure port 874, and the SS/V IN 27 and SS/V OUT 28 are easily connected to each other by forming the back pressure port 874 close to the SS/V IN accommodating hole 847 and the SS/V OUT accommodating hole 848 in the Z-axis direction, thereby simplifying the oil passages. The back pressure port 874 may be opened in the left side surface 806. In this embodiment, the back pressure port 874 is opened in the right side surface 805. The connector part 903 is not adjacent to the right side surface 805. Thus, compared with a case in which the back pressure port 874 is adjacent to the left side surface 806, the interference between the connector (harness) connected to the connector part 903 and the pipe 10X connected to the back pressure port 874 can be suppressed. In other words, when the back pressure port 874 is connected to the pipe 10X, the connection can easily be carried out. Thus, the mounting workability of the braking system 1 in the vehicle can be increased.

(Suppression of Vibration and Improvement in Support Rigidity)

The housing 8 (second unit 1B) is fixed to the vehicle body side via the mount 102. Thus, supportability of the structure configured to support the housing 8 can be improved. Moreover, a rotation force of the motor 20 acts as a reaction force on the motor housing 200 and the housing 8 via bearings of the motor rotation shaft and the pump rotation shaft. Vibration occurs mainly in the circumferential direction of the axial center O in the second unit 1B by the reaction force during operation of the motor 20 (pump 3). The housing 8 (second unit 1B) is supported by the vehicle body side (mount 102) via the insulators 103 and 104. The insulators 103 and 104 are configured to absorb the vibration generated by the operation of the second unit 1B. As a result, transmission of the vibration from the second unit 1B to the vehicle body side via the mount 102 is suppressed. Thus, silence of the braking system 1 can be achieved.

The second unit 1B can stably be held by supporting the bottom surface 804 and the front surface 801 of the housing 8 at the four locations as follows. The bolt holes 895 are opened in the bottom surface 804. Thus, the second unit 1B can stably be supported with respect to the vehicle body side (mount 102) by the bolts B3 fixed to the bolt holes 895 receiving the weight (load in the vertical direction) of the second unit 1B in axial directions of the bolts 133. The bolt holes 894 are opened in the front surface 801. The center of gravity of the second unit 1B is displaced to the front surface 801 side with respect to the center of gravity of the housing 8 due to the mounting of the motor 20. The second unit 1B is caused to fall toward the front surface 801 side due to the weight of the motor 20. The second unit 1B can stably be supported with respect to the vehicle body side (mount 102) by the bolts B4 fixed into the bolt holes 894 receiving the load in the falling direction of the second unit 19 in axial directions of the bolts B4. The bolt holes 894 are formed on the negative side in the Z-axis direction on the front surface 801. Thus, the size of an arm part of the mount 102 can be decreased, thereby being capable of improving mountability of the braking system 1.

The two bolt holes 895 are opened in the bottom surface 804. Thus, the second unit 1B can more stably be supported by supporting the housing 8 at the two points. Moreover, a load acting on each of the bolt holes 895 can be decreased by distributing the load of the second unit 1B to the two bolt holes 895 (bolts B3) for support. Dimensions of each of the bolt holes 895 can be decreased, thereby being capable of decreasing the size of the housing 8. The center of gravity of the second unit 1B is located on the center side in the X-axis direction (on the side closer to the axial center O). The two bolt holes 895 are formed on the both sides in the X-axis direction with respect to the axial center O on the bottom surface 804. Thus, the second unit 1B can more stably be supported by fixing the housing 8 on the both sides with respect to the center of gravity. Moreover, the vibration of the second unit 1B in the circumferential direction of the axial center O can effectively be suppressed by fixing the housing 8 at the plurality of positions separated in the circumferential direction of the axial center O. The two bolt holes 895 are formed at the ends on the both sides in the X-axis direction on the bottom surface 804. Thus, the second unit 1B can more stably be supported by increasing the distance between the support points. Moreover, the load acting on the bolt hole 895 can be decreased by increasing the distance in the X-axis direction from the center of gravity of the second unit 113 to the bolt hole 895. Similarly, the two bolt holes 894 are opened in the front surface 801. The two bolt holes 894 are formed on the both sides in the X-axis direction with respect to the axial center O. The bolt holes 894 are formed at the ends on the both sides in the X-axis direction on the front surface 801. Thus, the bolt holes 894 respectively provide the same actions and effects as described above. The axial center of each of the bolt holes 894 is in the X-axis direction, and is arranged so as to be separated more from the axial center O than the axial center of each of the bolt holes for the motor mounting on the front surface 801. Thus, the second unit 1B can more stably be supported by increasing the distance between the support points.

The external devices (the master cylinder 5, the wheel cylinders W/C, and the stroke simulator 6) are connected to the housing. 8 by the pipes 10M, 10W, and 10X. The housing 8 can efficiently be supported through the pipes 10M, 10W, and 10X. The external device may to be separately outside the second unit 1B, and may be, for example, a hydraulic pressure unit including a second pump (third hydraulic pressure source) other than the third pump, a second motor configured to drive the second pump, an ECU configured to control the number of revolutions of the second motor, and the like. In this case, the second pump is connected to the second unit 1B by a pipe, and can supply a hydraulic pressure to the second unit 1B. A port of the second unit 1B to which the pipe is connected is opened, for example, on the right side surface 805 like the back pressure port 874, and is connected to the supply oil passages inside the housing 8. The brake fluid discharged from the second pump is supplied to the supply oil passages 11 via the pipe.

Each of the pipes 10M, 10W, and 10X is a metal pipe, and has rigidity equivalent to that of the mount 102. A support structure constructed of the pipes 10M, 10W, and 10X can have the rigidity equivalent to that of the mount 102. The respective pipes 10M, 10W, and 10X can increase support rigidity for the housing 8. For example, when the sensors (for example, an angular velocity sensor) configured to detect the motion state of the vehicle are mounted to the control board 900, misdetection of the vibration as the motion (yaw rate and the like) of the vehicle body can be suppressed by suppressing the vibration of the second unit 1B. Moreover, the sizes of the insulators 103 and 104 can be decreased, thereby improving the mountability of the braking system 1.

The respective pipes 10M, 10W, and 10X bend a plurality of times. The rigidity of the metal pipe increases after the bending. The support rigidity for the housing 8 by the respective pipes 10M, 10W, and 10X can be increased by bending the respective pipes 10M, 10W, and 10X a plurality of times. For example, the back pressure pipe 10X bends a plurality of times between the first unit 1A and the back pressure port 874. Thus, the support rigidity for the housing 8 by the back pressure pipe 10X can be increased.

The two master cylinder ports 871, the four wheel cylinder ports 872, and the one back pressure port 874 are formed on the housing 8, and the pipes 10MP, 10MS, 10W (FL), 10W (RR), 10W (FR), 10W (FR), and 10X are respectively connected to those ports. The supportability for the housing 8 can be increased by supporting the housing 8 at a total of seven portions by the pipes in this way.

The master cylinder pipes 10M and the wheel cylinder pipes 10W are connected on the positive side in the Z-axis direction to the housing 8, and the back pressure pipe 10X is connected on the negative side in the Z-axis direction to the housing 8 with respect to the axial center O. Thus, the supportability for the housing 8 by the respective pipes 10M, 10W, and 10X can be increased by connecting the pipes 110M, 10W, and 10X to the housing 8 on the both sides in the Z-axis direction with respect to the axial center O.

The master cylinder ports 871 are opened in the front surface 801. Thus, the second unit 1B can stably be supported with respect to the vehicle body side by the pipes 10M fixed into the master cylinder ports 871 receiving the load in the falling direction of the second unit 1B in axial directions of the pipes 10M like the bolts B4 on the front surface 801. The master cylinder ports 871 are formed on the positive side in the Z-axis direction with respect to the axial center O. Thus, the load in the falling direction can efficiently be received by the master cylinder pipes 10M, and the second unit 1B can thus stably be supported. Moreover, the housing 8 can be fixed at the positions on the both sides of the center of gravity of the second unit 1B by the bolts B4 (on the negative side in the Z-axis direction with respect to the axial center O) and the master cylinder pipes 10M on the front surface 801. Therefore, the second unit 1B can more stably be supported. Moreover, the vibration of the second unit 1B in the circumferential direction of the axial center O may be transmitted to the first unit 1A via the metal pipes (master cylinder pipes 10M and the back pressure pipe 10X), and may further be transmitted to the dash panel on the vehicle body side via the flange part 78. Noise may occur in the vehicle cabin as a result of the transmission of the vibration to the dash panel. The two master cylinder ports 871P and 871S are arranged in a row in the X-axis direction. Thus, the vibration of the second unit 1B can effectively be suppressed by fixing the housing 8 through the pipes 10M at the plurality of positions separated in the circumferential direction of the axial center O. As a result, the vibration transmitted to the vehicle body side via the first unit 1A (flange part 78) can be decreased, thereby being capable of achieving the silence in the vehicle cabin.

The wheel cylinder ports 872 are opened in the top surface 803. Thus, the pipes 10W fixed to the wheel cylinder ports 872 pull the housing 8 in their axial direction (to the positive side in the Z-axis direction), and receive the load of the second unit 1B, thereby enabling stable support for the second unit 1B with respect to the vehicle body side. The wheel cylinder ports 872 are formed on the positive side in the Z-axis direction with respect to the axial center O. Thus, the housing 8 is fixed at the positions on the both sides of the center of gravity of the second unit 1B by the bolts B3 on the bottom surface 804 and the wheel cylinder pipes 10W. Thus, the second unit 1B can more stably be supported. Moreover, the four wheel cylinder ports 872 are arranged in a row in the X-axis direction. Thus, the vibration of the second unit 1B in the circumferential direction of the axial center O can effectively be suppressed by fixing the housing 8 at the plurality of positions separated in the circumferential direction of the axial center O. Particularly, the wheel cylinder ports 872 are opened in the top surface 803, which is a surface along the circumferential direction of the axial center O. The vibration of the second unit 1B in the circumferential direction of the axial center O can more effectively be suppressed by the tensile forces of the wheel cylinder pipes 10W acting on the housing 8 in the direction away from the axial center O.

The back pressure port 874 is opened in the right side surface 805. Thus, the pipe 10X fixed into the back pressure port 874 pulls the housing 8 in its axial direction (to the positive side of the X axis) to receive the load of the second unit 1B, to thereby enable stable support for the second unit 1B with respect to the vehicle body side. The back pressure port 874 is formed on the negative side in the Z-axis direction with respect to the axial center O. Thus, the housing 8 is fixed at the positions on the both sides of the center of gravity of the second unit 1B by the master cylinder pipes 10M and the wheel cylinder pipes 10W on the positive side in the Z-axis direction with respect to the axial center O and the back pressure pipe 10X in the negative side in the Z-axis direction, Thus, the second unit 1B can more stably be supported. Moreover, distances between the master cylinder pipes 10M and the wheel cylinder pipes 10W, and the back pressure pipe 10X are long in the circumferential direction of the axial center O. Thus, the vibration of the second unit 1B in the circumferential direction of the axial center O can effectively be suppressed by increasing the distances between the fixing positions of the housing 8 in the circumferential direction of the axial center O. Particularly, the back pressure port 874 is opened in the right side surface 805, which is a surface along the circumferential direction of the axial center O. The vibration of the second unit 1B in the circumferential direction of the axial center O can more effectively be suppressed by the tensile force of the back pressure pipe 10X acting on the housing 8 in the direction away from the axial center O. The vibration of the second unit 1B in the circumferential direction of the axial center O can more effectively be suppressed by arranging the action points of the tensile forces by the wheel cylinder pipes 10W and the action point of the tensile force by the back pressure pipe 10X on both sides in the Z-axis direction h respect to the axial center O.

### Second Embodiment

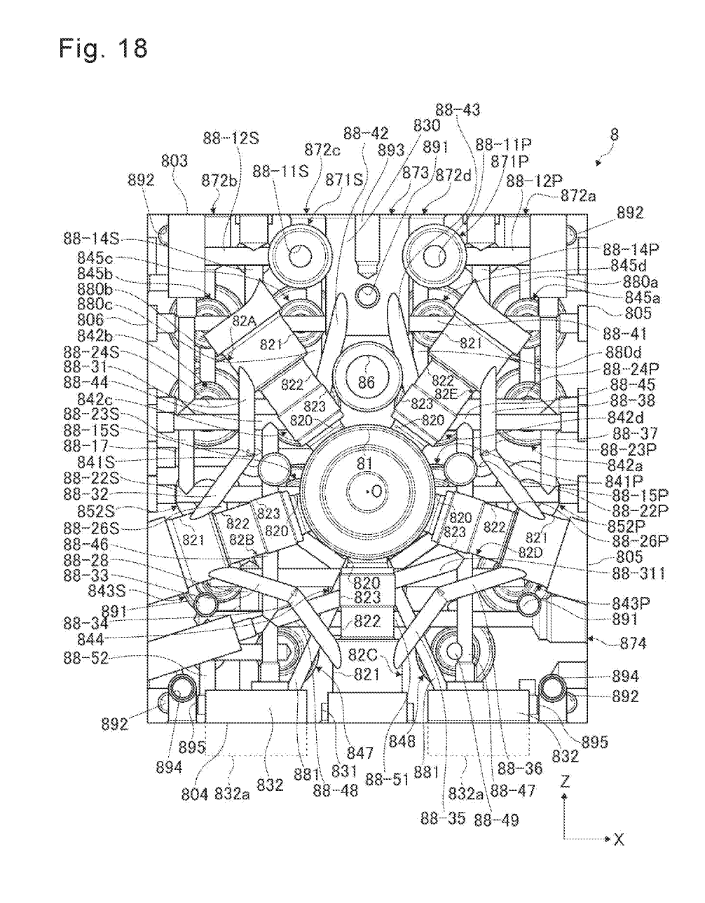

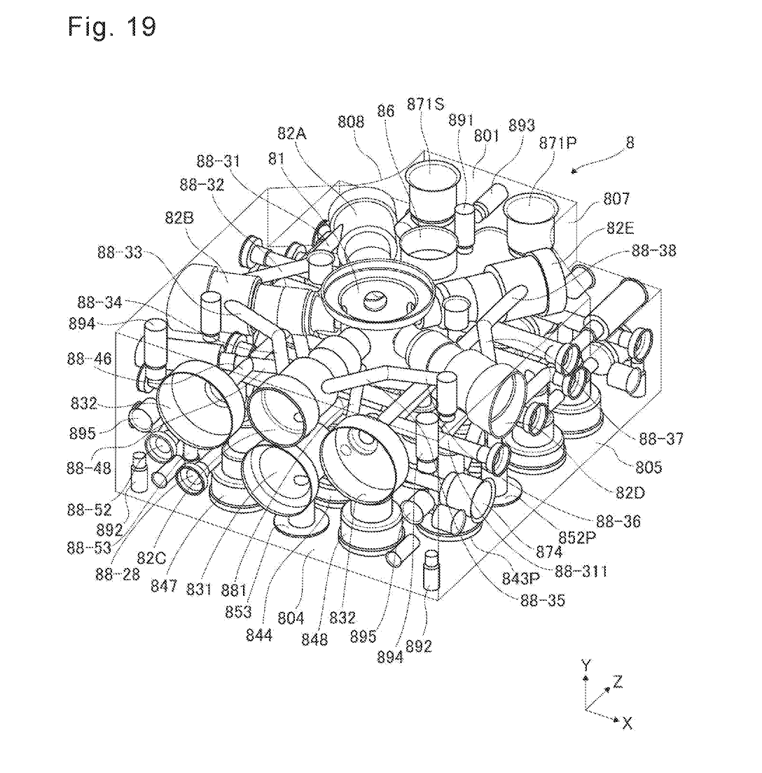

First, a description is given of a configuration. The housing 8 of the second embodiment includes two liquid reservoir chambers 832. FIG. 18 and FIG. 19 are views for illustrating passages, recessed parts, and holes in this embodiment with transparently in the housing 8. FIG. 18 is a front transparent view similar to FIG. 4. FIG. 19 is a transparent view for illustrating the housing 8 as viewed from the positive side of the X axis, the positive side of the Y axis, and the negative side in the Z-axis direction. The two liquid reservoir chambers 832 are provided on the both sides in the X-axis direction with respect to the axial center O so as to sandwich the cylinder accommodating hole 82C, and are opened in the bottom surface 804. Each of the liquid reservoir chambers 832 is connected to the cam accommodating hole 81 via the oil passage hole 881. Each of the liquid reservoir chambers 832 is smaller in volume of the small-diameter part 832s and the medium-diameter part 832m, and smaller in dimension in the Z-axis direction than that of the first embodiment. The eighth hole 88-48 of the fourth hole group 88-4 is provided on the opposite side of that of the first embodiment in the X-axis direction with respect to the axial center O. As illustrated as broken lines of FIG. 18, lid members 832a close the openings of the liquid reservoir chambers 832, and protrude from the bottom surface 804. A sum of the volume of the liquid reservoir chamber 832 and the volume of the lid member 832a is a substantial capacity of the liquid reservoir chamber 832. The lid member 832a is provided so that its position in the Z-axis direction is adjustable with respect to the housing 8 (bottom surface 804) by means of, for example, a thread or the like, to thereby enabling a change in substantial capacity of the liquid reservoir chamber 832. Other configurations are the same as that of the first embodiment.

A description is now given of actions and effects. Compared with the first embodiment, the volume of each of the liquid reservoir chambers 832 is smaller inside the housing 8, but a large capacity can be secured as a whole by providing the two liquid reservoir chambers 832. Moreover, the capacity of the liquid reservoir chamber 832 can be adjusted by adjusting the position in the Z-axis direction of the lid member 832a in accordance with a required amount of the liquid for the liquid reservoir chamber 832. The number of the liquid reservoir chambers 832 is not limited to two. The other actions and effects are the same as those of the first embodiment.

### Other Embodiments

The embodiments of the present invention have been described above based on the drawings. However, the specific configuration of the present invention is not limited to the configuration described in each of the embodiments. A change in design or the like without departing from the scope of the gist of the invention is encompassed in the present invention. Further, within a range in which the above-mentioned problems can be at least partially solved or within a range in which the above-mentioned effects are at least partially obtained, a suitable combination or omission of the components recited in the claims and described in the specification is possible.

The present application claims priority to the Japanese Patent Application No. 2015-166544 filed on Aug. 26, 2015. The entire disclosure including the specification, the claims, the drawings, and the abstract of Japanese Patent Application No. 2015-166544 filed on Aug. 26, 2015 is incorporated herein in its entirety by reference.

### REFERENCE SIGNS LIST

1 braking system, 1A first unit (master cylinder unit), 1B second unit (pump unit), 10M master cylinder pipe (metal pipe), 10W wheel cylinder pipe (metal pipe), 10X back pressure pipe (metal pipe), 16 back pressure oil passage, 20 motor, 3 pump (pump device), 5 master cylinder (external device). 6 stroke simulator (external device), 8 housing (pump device), 801 front surface (motor mounting surface), 803 top surface, 805 right side surface, 871 master cylinder port, 872 wheel cylinder port, 874 back pressure port, 894 bolt hole (fixing part), 895 bolt hole (fixing part), W/C wheel cylinder (hydraulic pressure generation part)

1. A pump device comprising:
a housing including therein an oil passage and a pump;
a motor configured to drive the pump;
a motor mounting surface which is formed on one side surface of the housing, and to which the motor is mounted;
a first port which is formed on the motor mounting surface, and to which a pipe connected to a master cylinder is mounted;
a first surface formed so as to continue to the motor mounting surface, and including a second port to which a pipe connected to a wheel cylinder is mounted;
a second surface formed so as to continue to the motor mounting surface and the first surface; and
a third port which is formed on the second surface, and to which a pipe connecting an external device and the oil passage to each other is fixed.

2. The pump device according to claim 1,
wherein the external device is a master cylinder unit including a master cylinder and a stroke simulator configured to generate an operation reaction force through an outflow of brake fluid in a liquid chamber through a brake operation by a driver, and
wherein the brake fluid flowed out from the liquid chamber flows through the pipe fixed to the third port.

3. The pump device according to claim 2, further comprising:
a case mounted to a surface opposing the motor mounting surface of the housing, and accommodating a control board configured to control the motor; and
a connector provided in the case, and configured to supply a current to the control board,
wherein the connector is provided adjacently to a fourth surface opposing the second surface.

4. The pump device according to claim 1, wherein each of the pipes is a metal pipe.

5. The pump device according to claim 4,
wherein the motor is of a rotation type, and
wherein, when the first surface is a top surface, the first port is formed above an axis of a rotation shaft of the motor, and the third port is formed below the axis of the rotation shaft of the motor.

6. The pump device according to claim 5, wherein the pipe fixed to the third port is bent a plurality of times between the external device and the first port.

7. The pump device according to claim 1, wherein the housing includes two first ports, four second ports, and one third port.

8. The pump device according to claim 1,
wherein the motor is of a rotation type,
wherein an electromagnetic valve configured to open and close the oil passage is mounted to the housing, and
wherein the housing includes a pump region in which the pump is accommodated and an electromagnetic valve region in which the electromagnetic valve is arranged, which regions are arranged in this order from the motor mounting surface side along an axial direction of a rotation shaft of the motor.

9. A pump device comprising:
a rotation motor mounted to a mounting surface formed on a housing;
a pump driven by the rotation motor, and configured to discharge brake fluid to an oil passage provided inside the housing;
a first port which is provided on the mounting surface, and to which a first pipe for taking into the oil passage the brake fluid flowed out from a first external device through a brake operation by a driver is connected;
a first surface formed so as to continue to the mounting surface;
a second surface formed so as to continue to the mounting surface and the first surface;
a second port which is provided on the first surface, and to which a pipe connected to a second external device is connected; and
a third port which is provided on the second surface, and to which a second pipe for taking into the oil passage the brake fluid flowed out from a third external device through the brake operation by the driver is fixed.

10. The pump device according to claim 9, further comprising a fixing part provided on the mounting surface, and configured to fix the housing to a vehicle body.

11. The pump device according to claim 10, further comprising:
a case mounted to a surface opposing the mounting surface of the housing, and accommodating a control board configured to control the rotation motor; and
a connector provided in the case, and configured to supply a current to the control board,
wherein the connector is provided adjacently to a third surface opposing the second surface.

12. The pump device according to claim 11,
wherein the second external device is a master cylinder unit including a master cylinder and a stroke simulator configured to generate an operation reaction force through an outflow of the brake fluid in a fluid chamber through the brake operation by the driver, and
wherein the brake fluid flowed out from the liquid chamber flows through the second pipe fixed to the third port.

13. The pump device according to claim 9, wherein each of the pipes is a metal pipe.

14. The pump device according to claim 13, wherein, when the first surface is a top surface, the first port is formed above an axis of a rotation shaft of the rotation motor, and the third port is formed below the axis of the rotation shaft of the rotation motor.

15. The pump device according to claim 9, wherein each of the pipes is a metal pipe, and is bent a plurality of times.

16. A braking system comprising:
a master cylinder unit; and
a pump unit,
the master cylinder unit including:
a master cylinder configured to be operated in accordance with a brake operation by a driver; and
a stroke simulator configured to generate a reaction force against the brake operation by the driver,
the pump unit including:
an oil passage formed in a housing;
a pump provided in the housing, and configured to supply an operation hydraulic pressure to a hydraulic pressure generation part provided at a wheel;
a motor mounted to a motor mounting surface of the housing, and configured to drive the pump;
a first port formed on the motor mounting surface;
a first surface formed so as to continue to the motor mounting surface, and including a second port to which a metal pipe connected to the hydraulic pressure generation part is mounted;
a second surface formed so as to continue to the motor mounting surface and the first surface;
a fixing part provided on the motor mounting surface, and configured to fix the housing to a vehicle body; and
a third port which is formed on the second surface, and to which a metal pipe connecting the stroke simulator and the oil passage to each other is fixed.

17. The braking system according to claim 16, wherein the pump unit includes, integrally with the housing:
an electromagnetic valve configured to permit an inflow of brake fluid into the stroke simulator; and
a control unit configured to drive the pump and the electromagnetic valve.

18. The braking system according to claim 16,
wherein the pump unit includes:
a case mounted to a surface opposing the motor mounting surface of the housing, and accommodating a control board configured to control the motor; and
a connector provided in the case, and configured to supply a current to the control board, and
wherein the connector is provided adjacently to a third surface opposing the second surface.
